(19) United States
(12) Patent Application Publication
(10) Pub. No.: US 2023/0252214 A1
(43) Pub. Date: Aug. 10, 2023

(54) PROVIDING FILL PATTERNS FOR INTEGRATED CIRCUIT DEVICES

(71) Applicant: Intel Corporation, Santa Clara, CA (US)

(72) Inventors: Richard Hudeczek, Munich (DE); Carla Moran Guizan, Munich (DE); Peter Baumgartner, Munich (DE); Richard Geiger, Munich (DE); Alexander Bechtold, Feldkirchen (DE); Uwe Hodel, Putzbrunn (DE); Walther Lutz, Erding (DE); Georgios Panagopoulos, Munich (DE); Johannes Xaver Rauh, Kirchseeon (DE); Roshini Sachithanandan, Munich (DE)

(21) Appl. No.: 17/666,616

(22) Filed: Feb. 8, 2022

(51) Int. Cl. G06F 30/392; H01L 27/02

(52) U.S. Cl. CPC G06F 30/392; H01L 27/0207

(57) ABSTRACT

Methods for providing fill patterns for IC devices are disclosed. An example method includes detecting a first device and a second device in an image, e.g., a two- or three-dimensional image representing the IC device. A line is defined based on the devices. The line divides the image into a first section and a second section. A first structure is generated based on the first device. A second structure is generated based on the second device. The second structure is a mirror image of the first structure across the line. A first fill pattern is generated in the first section based on the first structure. A second fill pattern is generated in the second section based on the first fill pattern, e.g., through a reflection transformation of the first fill pattern across the line. The two fill patterns represent patterns of fill structures to be included in the IC device.

### TECHNICAL FIELD

This disclosure relates generally to the field of semiconductor devices, and more specifically, to integrated circuit (IC) devices.

### BACKGROUND

For the past several decades, the scaling of features in ICs has been a driving force behind an ever-growing semiconductor industry. Scaling to smaller and smaller features enables increased densities of functional units on the limited real estate of semiconductor chips. For example, shrinking transistor size allows for the incorporation of an increased number of memory or logic devices on a chip, lending to the fabrication of products with increased capacity. Buried power rails (BPRs) can be a key scaling booster for complementary metal-oxide-semiconductor (CMOS) extension, e.g., beyond the 5-nm node.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A-1C illustrate an IC device including a fill pattern, according to some embodiments of the disclosure.

FIGS. 2A-2C illustrate a process of providing a symmetric fill pattern for an IC device, according to some embodiments of the disclosure.

FIGS. 3A-3E illustrate another process of providing a symmetric fill pattern for an IC device 300, according to some embodiments of the disclosure.

FIG. 4 illustrates an IC device that includes a fill pattern formed based on multiple symmetry axes, according to some embodiments of the disclosure.

FIGS. 5 and 6 illustrate symmetric arrangements of fill structures in multiple layers, according to some embodiments of the disclosure.

FIGS. 7A and 7B illustrates fill patterns for an IC device having a point symmetric layout, according to some embodiments of the disclosure.

FIGS. 8A-E illustrate a process of providing a fill pattern for an IC device including filling regions of different sizes, according to some embodiments of the disclosure.

FIGS. 9A-E illustrates a process of providing a fill pattern by linking filling regions, according to some embodiments of the disclosure.

FIGS. 9A-9E illustrates a process of providing a fill pattern by linking filling regions, according to some embodiments of the disclosure.

FIGS. 10A-10F illustrates a process of providing a fill pattern for an IC device based on simulation, according to some embodiments of the disclosure.

FIG. 11 illustrates vertical adjustment of a fill pattern, according to some embodiments of the disclosure.

FIGS. 12A-12C illustrates providing a fill pattern based on device pitches, according to some embodiments of the disclosure.

FIG. 13 is a flowchart showing a method of providing a fill pattern for an IC device, in accordance with various embodiments.

FIG. 14 is a flowchart showing another method of providing a fill pattern for an IC device, in accordance with various embodiments.

FIGS. 15A-15B are top views of a wafer and dies that may include fill structures, according to some embodiments of the disclosure.

FIG. 16 is a side, cross-sectional view of an example IC package that may include one or more IC devices having fill structures, according to some embodiments of the disclosure.

FIG. 17 is a cross-sectional side view of an IC device assembly that may include components having one or more IC devices implementing fill structures, according to some embodiments of the disclosure.

FIG. 18 is a block diagram of an example computing device, according to some embodiments of the disclosure.

### DETAILED DESCRIPTION

The systems, methods, and devices of this disclosure each have several innovative aspects, no single one of which is solely responsible for all of the desirable attributes disclosed herein. Details of one or more implementations of the subject matter described in this specification are set forth in the description below and the accompanying drawings.

For purposes of illustrating providing fill patterns for IC devices, proposed herein, it might be useful to first understand phenomena that may come into play in such structures. The following foundational information may be viewed as a basis from which the present disclosure may be properly explained. Such information is offered for purposes of explanation only and, accordingly, should not be construed in any way to limit the broad scope of the present disclosure and its potential applications.

Relentless scaling of transistors and wires in advanced semiconductor technologies has not only resulted in major process-related challenges but has also imposed severe design challenges in the sub-5 nm technology regime. Dimensional scaling of designs has been made possible by (i) Front-End-of-Line (FEOL) and Back-End-of-Line (BEOL) pitch scaling, which worsens short-channel effects in transistors and increases wire/contact resistances; and, (ii) fin depopulation in logic cells, which causes degradation of transistor drive. To enable further area scaling in sub-5 nm nodes, an approach of burying the power rails into the substrate has been proposed, which no longer requires reserving two routing tracks for power nets (e.g., VDD or VSS) in the logic cell area. Additionally, these BPRs can achieve a higher aspect ratio, thus, exhibiting lower resistance than local level BEOL power rails. BPRs can be a key scaling booster for CMOS extension beyond the 5-nm node. Power lines which conventionally run outside substrates can be replaced with power lines “buried” within substrates, e.g., within a shallow trench isolation (STI) layer and Si substrate. Such power lines are called BPRs. A BPR is a power rail that is at least partially buried in a support structure, e.g., a substrate, die, etc. A BPR includes an electrically conductive material, such as metal. A rail can have an elongated structure having a longitudinal axis as an axis along which a dimension of the rail is typically the longest (e.g., compared to dimensions of the rail along other two axes that may be used to define a three-dimensional configuration of the rail, where cross-sections of the rail along various planes that are perpendicular to the longitudinal axis are transverse cross-sections). The longitudinal axis may be parallel to the frontside surface or the backside surface of the support structure. BPR frees up routing resources, which results in logic cell height reduction and overall area scaling.

The BPR technologies bring very thick metals lines near to active devices. Since metals like copper, aluminum, and tungsten have higher thermal expansion coefficients than silicon, this can result in inhomogeneous mechanical stress, resulting in a shift of mobility in the active devices. This effect is also observed from thick metal in CMOS technologies, resulting in change of current. Since BPR brings thick metals even closer, an even larger change is expected, which can be critical for high precision analog circuits. Some solutions attempting to address these challenges include providing fill patterns in IC devices. A fill pattern may include one or more fill structures, where a fill structure is a non-functional structure that is added to an IC device to facilitate fabrication of the IC device. For instance, a fill structure can release stress, improve density uniformity, prevent dishing, etc. during fabrication. Fill structures can have various shapes, such as rectangles, polygons, etc. Fill structures can include various materials, such as metal, oxide, other types of materials, or some combination thereof.

The existing fill solutions can further introduce unwanted asymmetries to differential or array circuits. The existing fill procedures are usually optimized for the process requirements but do not count in layout and design symmetries. The existing fill procedures can create different sized fill structures, which are often placed opportunistically on a staggered pattern. Those introduced asymmetries results in degraded circuit performance, such as asymmetric capacitances, offset voltages for analog, the generation of harmonic frequencies for RF (radio frequency) and mmWave (millimeter wave) circuits, etc. Therefore, improved fill approaches are needed to preserve the intended layout symmetry.

Embodiments of the present disclosure relate to computer-implemented methods for providing fill patterns for IC devices that may improve on at least some of the drawbacks and challenges described above, as well as the resulting devices and systems.

An example computer-implemented method includes detecting a first device and a second device in an IC device. The first device and second device are functional. For instance, the first or second device is a functional component in the IC device, such as an electronic component. A line is generated based at least on the first device and the second device. The line divides the IC device into a first section, in which the first device is located, and a second section, in which the second device is located. The second device is transformed into a structure in the first section, e.g., through a reflection transformation across the line. The structure is merged with the first device to form a merged structure. A shape of the merged structure may be the shape of the first device or the shape of the structure. Alternatively, the shape of the merged structure is a combination of the shape of the structure and the shape of the first device. A first fill pattern is generated based on the merged structure. The first fill pattern includes fill structures in the first section. A second fill pattern is generated based on the first fill pattern. The second fill pattern includes fill structures in the second section. The second fill pattern may be a mirror image of the first fill pattern across the line.

Another example computer-implemented method includes generating a fill pattern in an IC device and analyzing an impact of the fill pattern on a first device or a second device in the IC device. The fill pattern includes fill structures surrounding at least a portion of the first device and at least a portion of the second device. The impact includes mechanical stress (e.g., mechanical stress exerted by fill structures on the first or second device), electrical coupling (e.g., electrical coupling between fill structures and the first or second device, or electrical coupling between the first device and the second device), magnetic coupling (e.g., magnetic coupling between fill structures and the first or second device, or magnetic coupling between the first device and the second device), thermal coupling (e.g., thermal coupling between fill structures and the first or second device, or thermal coupling between the first device and the second device), other types of impact, or some combination thereof. A critical region in the IC device is determined based on the impact. Further, one or more fill structures in the critical region are modified to reduce or minimize the impact.

Embodiments of the present disclosure provide fill patterns that may preserve layout symmetry of IC devices. The fill patterns can minimize asymmetries with high reproducibility. The fill patterns can also reduce impacts of fill structures on active devices and thereby enables higher reliability and performance of those devices.

IC devices as described herein, in particular IC devices with fill patterns as described herein, may be used for providing electrical connectivity to one or more components associated with an IC or/and between various such components. In various embodiments, components associated with an IC include, for example, transistors, diodes, power sources, resistors, capacitors, inductors, sensors, transceivers, receivers, antennas, etc. Components associated with an IC may include those that are mounted on IC or those connected to an IC. The IC may be either analog or digital and may be used in a number of applications, such as microprocessors, optoelectronics, logic blocks, audio amplifiers, etc., depending on the components associated with the IC. The IC may be employed as part of a chipset for executing one or more related functions in a computer.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For convenience, if a collection of drawings designated with different letters are present, such a collection may be referred to herein without the letters.

In the drawings, some schematic illustrations of example structures of various devices and assemblies described herein may be shown with precise right angles and straight lines, this is simply for ease of illustration, and embodiments of these assemblies may be curved, rounded, or otherwise irregularly shaped as dictated by, and sometimes inevitable due to, the manufacturing processes used to fabricate semiconductor device assemblies. Therefore, it is to be understood that such schematic illustrations may not reflect real-life process limitations which may cause the features to not look so “ideal” when any of the structures described herein are examined using, e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of device fabrication. Furthermore, although a certain number of a given element may be illustrated in some of the drawings (e.g., a certain number of devices, a certain number of fill structures, etc.), this is simply for ease of illustration, and more, or less, than that number may be included in an IC device with fill structures as described herein. Still further, various views shown in some of the drawings are intended to show relative arrangements of various elements therein. In other embodiments, various IC devices with fill structures as described herein, or portions thereof, may include other elements or components that are not illustrated (e.g., transistor portions, various components that may be in electrical contact with any of the transistors, etc.). Inspection of layout and mask data and reverse engineering of parts of a device to reconstruct the circuit using, e.g., optical microscopy, TEM, or SEM, and/or inspection of a cross-section of a device to detect the shape and the location of various device elements described herein using, e.g., Physical Failure Analysis (PFA) would allow determination of presence of IC devices with fill structures as described herein.

Various operations may be described as multiple discrete actions or operations in turn, in a manner that is most helpful in understanding the claimed subject matter. However, the order of description should not be construed as to imply that these operations are necessarily order dependent. These operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

For example, some descriptions may refer to a particular source or drain region or contact being either a source region/contact or a drain region/contact. However, unless specified otherwise, which region/contact of a transistor is considered to be a source region/contact and which region/contact is considered to be a drain region/contact is not important because under certain operating conditions, designations of source and drain are often interchangeable. Therefore, descriptions provided herein may use the term of a “S/D” region/contact to indicate that the region/contact can be either a source region/contact, or a drain region/contact.

In another example, if used, the terms “package” and “IC package” are synonymous, as are the terms “die” and “IC die,” the term “insulating” means “electrically insulating,” the term “conducting” means “electrically conducting,” unless otherwise specified. Although certain elements may be referred to in the singular herein, such elements may include multiple sub-elements. For example, “an electrically conductive material” may include one or more electrically conductive materials.

In another example, if used, the terms “oxide,” “carbide,” “nitride,” etc. refer to compounds containing, respectively, oxygen, carbon, nitrogen, etc., the term “high-k dielectric” refers to a material having a higher dielectric constant than silicon oxide, while the term “low-k dielectric” refers to a material having a lower dielectric constant than silicon oxide.

In yet another example, a term “interconnect” may be used to describe any element formed of an electrically conductive material for providing electrical connectivity to one or more components associated with an IC or/and between various such components. In general, the “interconnect” may refer to both conductive lines/wires (also sometimes referred to as “lines” or “metal lines” or “trenches”) and conductive vias (also sometimes referred to as “vias” or “metal vias”). In general, a term “conductive line” may be used to describe an electrically conductive element isolated by a dielectric material typically comprising an interlayer low-k dielectric that is provided within the plane of an IC chip. Such conductive lines are typically arranged in several levels, or several layers, of metallization stacks. On the other hand, the term “conductive via” may be used to describe an electrically conductive element that interconnects two or more conductive lines of different levels of a metallization stack. To that end, a via may be provided substantially perpendicularly to the plane of an IC chip or a support structure over which an IC device is provided and may interconnect two conductive lines in adjacent levels or two conductive lines in not adjacent levels. A term “metallization stack” may be used to refer to a stack of one or more interconnects for providing connectivity to different circuit components of an IC chip.

Furthermore, the term “connected” may be used to describe a direct electrical or magnetic connection between the things that are connected, without any intermediary devices, while the term “coupled” may be used to describe either a direct electrical or magnetic connection between the things that are connected, or an indirect connection through one or more passive or active intermediary devices. The term “circuit” may be used to describe one or more passive and/or active components that are arranged to cooperate with one another to provide a desired function.

The terms “substantially,” “close,” “approximately,” “near,” and “about,” generally refer to being within +/−20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

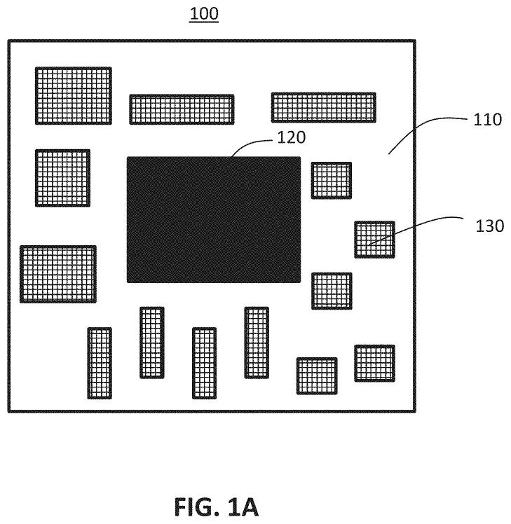

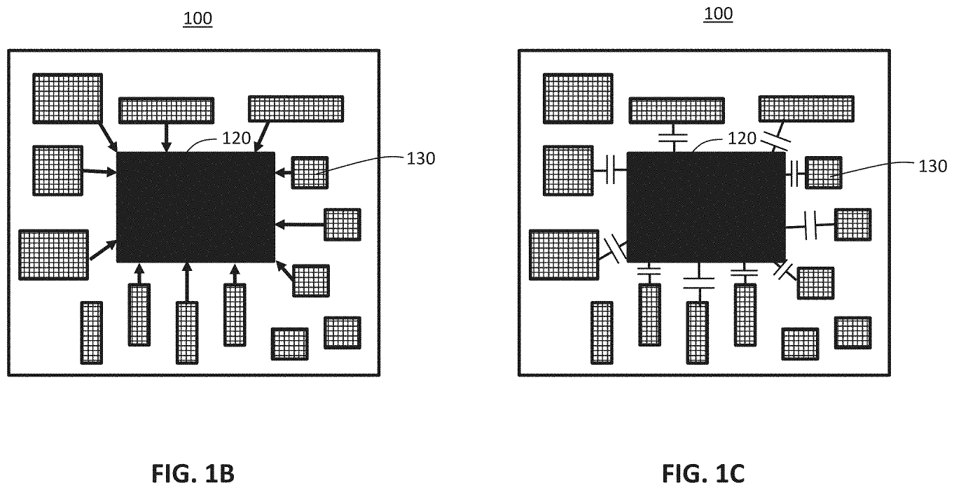

FIGS. 1A-1C illustrate an IC device 100 including a fill pattern, according to some embodiments of the disclosure. As shown in FIG. 1A, the IC device 100 includes a support structure 110, a device 120, and fill structures 130 (collectively referred to as “fill structures 130” or “fill structure 130”). The fill structures 130 constitute the fill pattern. In other embodiments, the IC device 100 may include fewer, more, or different components. For instance, the IC device 100 may include other devices.

The support structure 110 may be any suitable structure with which the device 120 can be associated. For instance, the support structure 110 may be a substrate, a die, a wafer, or a chip. In some embodiments, the support structure 110 may be a printed circuit board (PCB) substrate. In other embodiments, the support structure 110 is a semiconductor substrate, which is composed of semiconductor material systems including, for example, n-type or p-type materials systems. One or more transistors may be built on the support structure 110. In one implementation, the semiconductor substrate may be a crystalline substrate formed using a bulk silicon or a silicon-on-insulator substructure. In other implementations, the semiconductor substrate may be formed using alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-V, group II-VI, or group IV materials. In some embodiments, the substrate may be non-crystalline.

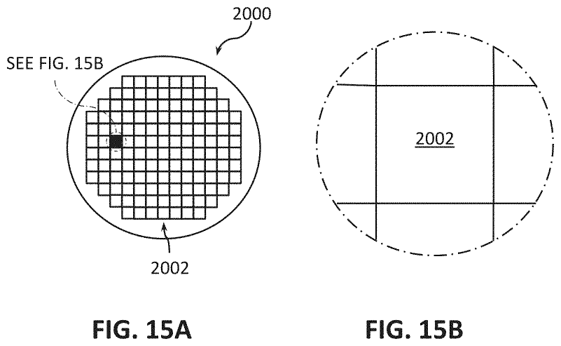

Although a few examples of materials from which the support structure 110 may be formed are described here, any material that may serve as a foundation upon which IC devices implementing fill patterns as described herein may be built falls within the spirit and scope of the present disclosure. In various embodiments, the support structure 110 may include any such substrate material that provides a suitable surface for forming the fill pattern. The support structure 110 may, e.g., be the wafer 2000 of FIG. 15A, discussed below, and may be, or be included in, a die, e.g., the singulated die 2002 of FIG. 15B, discussed below.

The device 120 is a functional component. The device 120 may perform an electronic function in the IC device 100. In some embodiments, the device 120 is an electronic component, such as a transistor, capacitor, resistor, power rail, wire, bus, and so on. In other embodiments, the device 120 is a collection of multiple electronic components, such as an amplifier, oscillator, timer, microprocessor, memory, and so on. The device 120 is associated with the support structure 110. In an embodiment, at least a portion of the device 120 is in the support structure 110. In another embodiment, the device 120 is attached on a surface of the support structure 110. In yet another embodiment, the device 120 is associated with the support structure 110 in other ways. For instance, the device 120 is coupled to the support structure 110 through another component, such as a via, a layer, etc.

A fill structure 130 is a non-functional structure that is added to the IC device 100 to facilitate fabrication of the IC device 100. For instance, the fill structures 130 can release stress, prevent dishing, facilitate uniform density, or provide other types of benefits during the fabrication. A fill structure 130 may be referred to as a dummy fill or floating fill in the IC device 100. In some embodiments, a fill structure 130 is not connected to any of a signal source, a power source, or a reference potential during operation of the IC device 100. For purpose of simplicity and illustration, the fill structures 130 are rectangular structures with various sizes. In other embodiments, the fill structures 130 can have other shapes. The fill structure 130 may be a structure of a metal, oxide, or other types of materials. The fill structures 130 are around the device 120, e.g., the fill structures 130 are located at one or more sides of the device 120. In the embodiment of FIG. 1A, the fill structures 130 surround the device 120.

The fill pattern is generated by identifying a filling space in the IC device 100. The filling space is the space in the IC device 100 that are not occupied by the device 120 (or other devices, if any). The fill pattern can be placed in a portion of, or the whole of, the filling space. In some embodiments, the fill pattern is generated based on one or more fill rules. A fill rule specifies a requirement for the fill pattern. Example fill rules may specify, for instance, shapes of fill structures, sizes of fill structures, pitches of fill structures (i.e., the distance between two adjacent fill structures), enclosures of fill structures (i.e., distances from fill structure to functional devices), layers (e.g., FEOL, BEOL, or BPR layers) where fill structures are placed, and so on. The fill rules can be a predetermined fixed set of rules, which is slightly adjusted regarding the device 120. In FIG. 1D, the fill pattern is placed into the filling space and the device 120 is surrounded by the fill structures 130.

However, the placement of the fill pattern can influence performance of the device 120. FIG. 1B shows mechanical stress suffered by the device 120. The fill structures 130 exert mechanical stress to their surroundings. As the device 120 is in close vicinity with the fill structures 130, the device 120 suffers from the mechanical stress. The arrows in FIG. 1E illustrate mechanical forces applied by the fill structures 130 on the device 120. This mechanical stress can change the electric performance of the device 120. In some embodiments, the mechanical stress may cause malfunction of the device 120.

FIG. 1C shows electrical stress suffered by the device 120. The device 120 can be electrically coupled to a fill structure 130 (or another component over the fill structure 130). The capacitor symbols in FIG. 1F illustrate the electrical coupling (e.g., capacitance, inductive coupling, etc.) between the device 120 and fill structures 130 close to the device 120. The electrical coupling can degrade the performance of the device 120, e.g., in high frequency applications. Given the mechanical stress and electrical coupling, the fill structures 130 can cause performance degradation of the device 120. Therefore, improved methods of providing fill patterns for IC devices are needed.

Even though not shown in FIGS. 1B and 1C, the fill structures 130 can apply other types of impact on the device 120, such as thermal coupling, magnetic coupling, etc. For instance, due to the thermal conductivity of the fill structures 130, the addition of the fill structures 130 can change (e.g., increase) the temperature of the device 120, which consequently degrades the performance of the device 120.

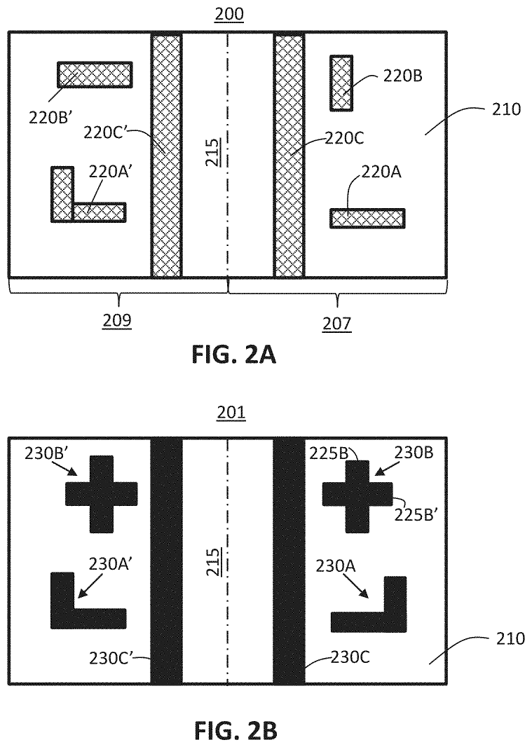

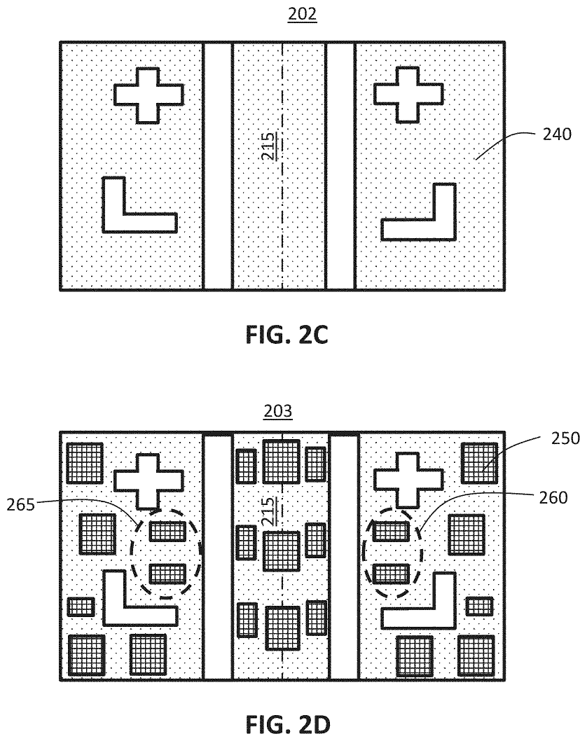

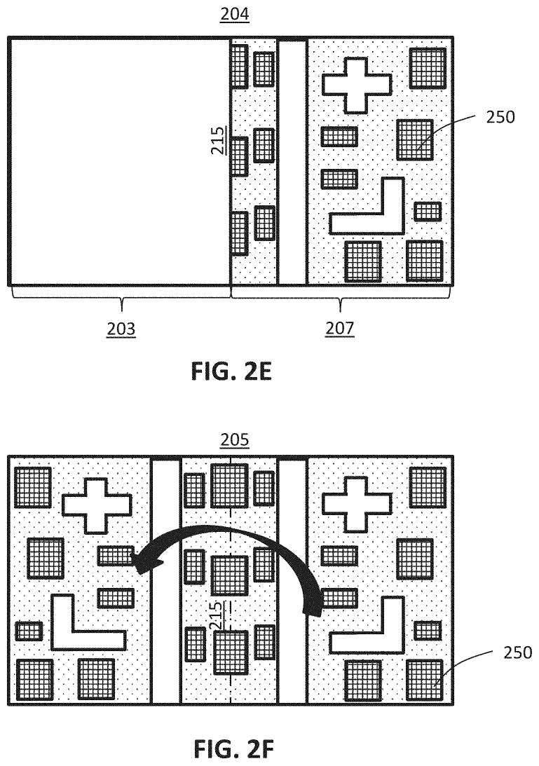

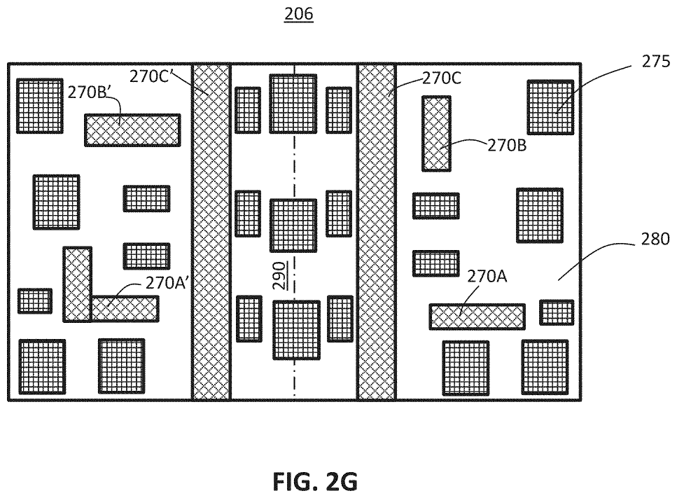

FIGS. 2A-2G illustrate a process of providing a symmetric fill pattern for an IC device, according to some embodiments of the disclosure. FIG. 2A shows an image 200 of the IC device. In some embodiments, the image 200 is a virtual representation of the IC device that is generated based on the IC device, e.g., by a computing system. The process illustrated in FIGS. 2A-2G can be performed on the image 200, e.g., by using a computing device. The image 200 may be a two-dimensional or three-dimensional image of the IC device.

As shown in FIG. 2A, the image 200 includes an object 210 and objects 220A, 220A′, 220B, 220B′, 220C, and 220C′ (collectively referred to as “objects 220” or “object 220”). The object 210 represents a support structure of the IC device, which may be the same as or similar to the support structure 110 in FIG. 1A. The objects represent devices in the IC device that are associated with the support structure. An object 220 may be the same as or similar to the device 120 in FIG. 1A. In other embodiments, the IC device may include fewer, more, or different components. For instance, the IC device may include a different number of devices. In FIG. 2A, the objects 220 are generated and detected. For instance, an object 220 can be generated based on the size, shape, function, location in the IC device, or other attributes of the corresponding device. As shown in FIG. 2A, the objects 220 have different shapes, different sizes, and different locations in the image 200.

Further, a line 215 is defined in the image 200. The line 215 may not represent any real components in the IC device. In some embodiments, the line 215 may be a symmetry axis of the IC device or of the image 200, or be a line crossing a symmetry point of the IC device. The symmetry axis of the IC device may be a symmetry axis of the support structure, a symmetry axis of some or all the devices, or a combination of both. In some embodiments, the line 215 is determined based on one or more pairs of objects 220. One example pair is the objects 220C and 220C′. The line 215 is determined as a symmetry axis of the pair, e.g., the object 220C is a mirror image of the object 220C′ across the line 215. Another example pair can be the objects 220A and 220A′, or the objects 220B and 220B′. The line 215 is in the middle of the objects 220A and 220A′ or the middle of the objects 220B and 220B′. The line 215 divides the image 200 into two sections 203 and 207. One or more dimensions of the section 209 can be the same as the corresponding dimensions of the section 207. In some embodiments, the section 209 has the same size as the section 207.

In FIG. 2B, another image 201 is generated by transforming and merging some or all of the objects 220 in the image 200. The image 201 includes structures 230A, 230A′, 230B, 230B′, 230C, and 230C′ (collectively referred to as “structures 230” or “structure 230”). A structure 230 can be generated through transformation of an object. The transformation of an object 220 may be a direction transformation (e.g., copying or moving), a reflection transformation (e.g., across the line 215), a rotation transformation, or some combination thereof. For instance, the structure 230C is generated by coping the object 220C. The structure 230C is identical (or substantially identical) identical to the object 220C. For instance, the structure 230C has identical (or substantially identical) shape, size, and location as the object 220C. Similarly, the structure 230C′ is generated by coping the object 220C′.

Alternatively, a structure 230 may be generated based on multiple objects 220 through transformation and merging. For example, the structure 230A is generated based on the objects 220A and 220A′. The object 220A is transformed to a structure (not called out in FIG. 2B) through copying the shape, size, and location of the object 220A. The object 220A′s is transformed to a structure 230A through a reflection transformation across the line 215. The structure 230A is then merged with the structure transformed from the object 220A. As a portion of the structure 230A overlaps with the structure transformed from the object 220A. The result of the merging is the structure 230A. The structure 230A′ may be generated by a transformation of the object 220A′ or the structure 230A. As another example, the object 220B is transformed to a structure 225B through copying the shape, size, and location of the object 220B. The object 220B′ is transformed to a structure 225B′ through a reflection transformation of the object 220B′ across the line 215. The structures 225B and 225B′ are then merged to form a merged structure 230B. Similarly, the object 220B′ is transformed to a merged structure 230B′. In some embodiments, the merged structure 230B′ is generated based on the merged structure 230B, e.g., through a reflection transformation of the merged structure 230B across the line 215.

In the image 201, each structure 230 is a mirror image of another structure 230 across the line 215. For instance, the structure 230A is a mirror image of the structure 230A′ across the line. Similarly, the structure 230B is a mirror image of the structure 230B′ across the line and the structure 230C is a mirror image of the structure 230C′ across the line. A structure 230 may have the same shape, size, and location as the object 220, from which the structure 230 is transformed. For instance, the structure 230C has the same shape, size, and location as the object 220C. Alternatively, a structure 230 may have a different shape, size, or even location as the object 220 from which the structure 230 is transformed. For instance, the structure 230A has a different shape and size from the object 220A.

A structure 230 may have a shape that is a combination of the shapes of two objects 220. The two objects 220 are at opposite sides of the line 215. For instance, the shape of the structure 230A is a combination of the shape of the object 220A and the shape of the object 220A′. Also, the shape of the structure 230B is a combination of the shape of the object 220B and the shape of the object 220B′. The image 201 has line symmetry across the line 215. Such a structure 230 can be formed by combining or merging the two objects 220.

In FIG. 2C, another image 202 is generated based on the image 201. In the image 202, a filling space 240 is identified. The filling space 240 represents a space in the IC device where fill structures can be added, e.g., a part of or a whole space that is not occupied by any of the devices. As shown in FIG. 2C, the structures 230 are “cropped out” from the image 201 to form the filling space 240.

FIG. 2D shows an image 203 that is generated based on the image 202. In FIG. 2D, a fill pattern is formed in the filling space 240. This fill pattern is referred to as the original fill pattern. The original fill pattern includes a plurality of fill structures 250 surrounding the structures 230. The fill structures 250 have different sizes and locations. For purpose of simplicity and illustration, the fill structures 250 all have rectangular shapes. In other embodiments, the fill structures 250 may have different types of shapes. The fill pattern can be formed based on a predefined set of fill rules, such as the fill rules described above in conjunction with FIGS. 1A-F.

FIG. 2D shows an image 204 that is generated based on the image 203. In FIG. 2E, the fill structures 250 in the section 209 are removed and the fill structures in the section 207 are kept. For a fill structure 250 that is partially in the section 209 and partially in the section 207, the portion that is in the section 209 is removed and the portion in the section 207 is kept. In other words, the section 209 is used as the crop section and the section 207 is used as the source section. The fill structures 250 in the section 209 constitute a crop fill pattern, i.e., a fill pattern that is cropped out. The fill structures 250 in the section 207 constitute source fill pattern, i.e., the fill pattern that is kept and will be used to generate a new fill pattern for the section 209.

FIG. 2F shows an image 205 that is generated based on the image 204. In FIG. 2F, a new fill pattern is generated by transforming the source fill pattern. The new fill pattern is a mirror image of the source fill pattern across the line 215. The new fill pattern is placed into the section 209. Accordingly, the whole fill pattern, which includes the source fill pattern and the new fill pattern, is symmetric across the line 215. The whole fill pattern represents a pattern of dummy fills to be included in the IC device.

FIG. 2G shows an IC device 206 that includes dummy fills 275 formed based on the fill pattern generated in FIG. 2F. Each dummy fill 275 corresponds to a fill structure 250 in FIG. 2F and is added to the IC device 206 based on the fill structure 250, such as the shape, size, location, or other attributes of the fill structure 250 in the image 205. The IC device 206 also includes devices 270A, 270A′, 270B, 270B′, 270C, and 270C′ (collectively referred to as “devices 270” or “device 270) and a support structure 280. Each device is represented by an object 220 in FIG. 2A. The support structure 280 is represented by the object 210 in FIG. 2A. The IC device 206 has a symmetry axis 290, which corresponds to the line 215 defined in the image 201. The device 270C′ is a mirror image of the device 270C′ across the symmetry axis 290. The symmetry axis 290 is in the middle of the devices 270A and 270A′. Also, the symmetry axis 290 is in the middle of the devices 270B and 270B′. The pattern of the dummy fills 275 are symmetric across the symmetry axis 290. As the pattern of the dummy fills 275 preserves the symmetry of the IC device 206, the mechanical stress and electrical coupling caused by the dummy fills 275 on the devices 270 can be offset as much as possible. Compared with the fill pattern in FIGS. 1A-1C, the influence of the fill pattern in FIG. 2G on the devices 170 are minimized. Thus, the process in FIGS. 2A-2G is more advantageous.

In some embodiments, in order to enable a symmetric filling, the formation of the original fill pattern in FIG. 2D (i.e., the fill pattern that includes both the source fill pattern and the crop fill pattern) may start on the line 215. However, this can cause that the fill patterns of the two sections 203 and 207 may be different from each other. In such embodiments, the fill patterns of the two sections 203 and 207 are evaluated and compared to determine which one is the source fill pattern, and which one is the crop fill pattern. One way to evaluate a fill pattern is to determine a quality of the fill pattern. In an embodiment, a fill pattern including fill structures of smaller sizes in a region of interest is considered as having a better quality. For instance, a region of interest 260 is identified in the section 207 and a region of interest 265 is identified in the section 209. In some embodiments, the region of interest 260 is identified based on the location of one or more objects 220 in the section 207. The one or more objects 220 may include an object 220 that is a mirror image of an object 220 in the section 209 across the line 215, an object 220 that is impacted by fill structures 250, or an object 220 that has a critical function. In the embodiment of FIG. 2D, the region of interest 260 is a region between the objects 220A and 220B. In other embodiments, the region of interest 260 may be a region that encloses or surrounds at least a portion of an object 220. The region of interest 265 may be identified through a reflection transformation of the region of interest 260 across the line 215.

After the regions of interest 260 and 265 are identified, one or more qualities of the fill structures 250 in the regions of interest 260 and 265 are determined and compared. A quality of a region of interest may be determined based on the fill structures 250 in the region of interest and one or more objects 220 associated with the region of interest, e.g., the objects 220 based on which the region of interest is identified. In an embodiment, the quality relates to distances from the fill structures 250 to the objects 220, such as an average or sum of the distances of individual ones of the fill structures 250 to individual ones of the objects 220. The average or sum may be a weight average or sum. For instance, an object 220 may have a higher weight than another object 220. In another embodiment, the quality is a mechanical stress exerted by the fill structures 250 on the objects 220. In yet another embodiment, the quality is a coupling (e.g., electrical coupling, thermal coupling, magnetic coupling, etc.) between the fill structures 250 and the objects 220. In yet another example, the quality is a size of the fill structures 250, e.g., an average of the sizes of the fill structures 250, a sum of the sizes of the fill structures 250, a weighted average of the sizes of the fill structures 250, or a weighted sum of the sizes of the fill structures 250. The quality of the region of interest 260 is compared with the quality of the region of interest 265. The section that has the region of interest having the better quality is selected as the source section. In some embodiments, the better quality is longer distance from the fill structures 250 to the objects 220, lower mechanical stress, less coupling, or smaller size of the fill structures 250.

In the embodiment of FIG. 2D, the original fill pattern covers both the two sections 203 and 207. This can ensure that one or more fill structures 250 would be placed on the line 215, which can help meet tight filling requirements. In other embodiments, the step in FIG. 2D may form a fill pattern that covers one of the sections but not cover the other section, and the fill pattern can be used as the source fill pattern. In those embodiments, the step in FIG. 2E can be skipped.

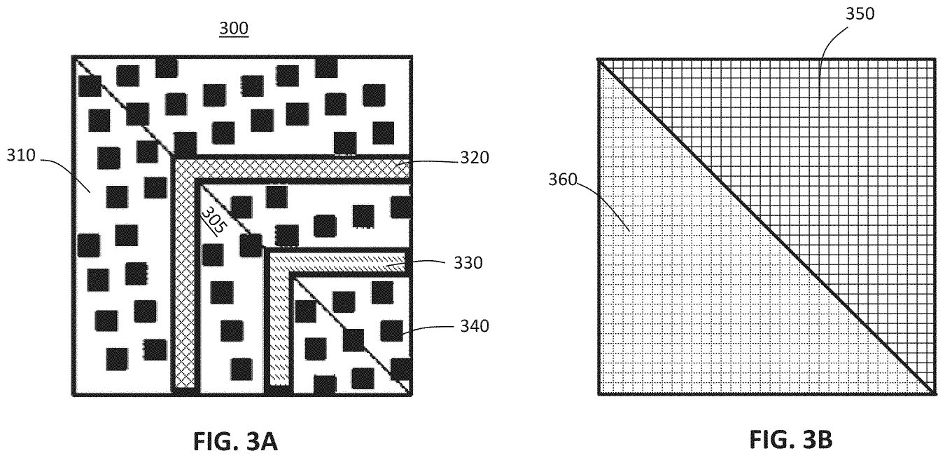

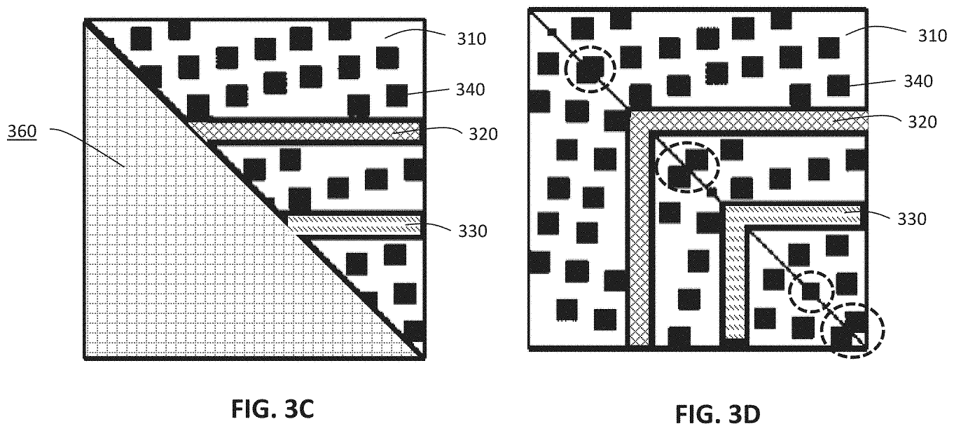

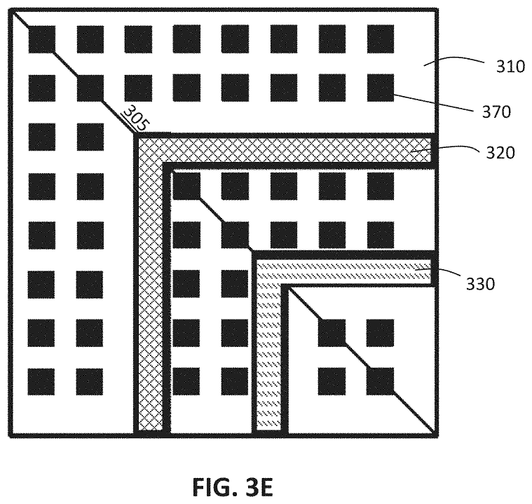

FIGS. 3A-3E illustrate another process of providing a symmetric fill pattern for an IC device 300, according to some embodiments of the disclosure. As shown in FIG. 3A, the IC device 300 includes a support structure 310 and devices 320 and 330. The support structure 310 may be the same as or similar to the support structure 110 in FIGS. 1A-F. The devices 320 and 330 are associated with the support structure 310. The device 320 or 330 may be the same as or similar to the device 120 in FIGS. 1A-F. In other embodiments, the IC device 300 may include fewer, more, or different components. For instance, the IC device 300 may include a different number of devices 320. In some embodiments, the process illustrated in FIGS. 3A-3E are performed by a computing device by using an image of the IC device 300.

In FIG. 3A, the devices 320 and 330 are identified. Also, a line 305 is determined. The line 305 is a symmetry axis of the IC device 300. In the embodiment of FIG. 3A, the line 305 is a symmetry axis of each of the support structure 310, the device 320, and the device 330. As shown in FIG. 3A, the line 305 is diagonal. A plurality of fill structures 340 surround the devices 320 and 330. For purpose of simplicity and illustration, the fill structures 340 all have square shapes and have same or similar sizes. In other embodiments, the fill structures 340 may have different types of shapes and different sizes. The fill structures 340 constitute a fill pattern. The fill pattern can be formed based on the process described above in conjunction with FIGS. 2A-2D.

In FIG. 3B, the IC device 300 is divided into a source section 350 and a crop section 360 along the line 305. The source section 350 and crop section 360 are at opposite sides of the line 305. In FIG. 3C, the fill structures 340 in the crop section 360 are removed but the fill structures 340 in the source section 350 are kept. For a fill structure 340 that is on the line 305 (i.e., a fill structure 340 that is partially in the source section 350 and partially in the crop section 360), the portion that is in the crop section 360 is removed and the portion in the source section 350 is kept.

In FIG. 3D, a mirror image of the fill pattern in the source section 350 is generated and placed into the crop section 360. However, as some fill structures are on the line 305 but is not symmetric across the line 305, invalid shapes are created from placing the mirror image of the fill pattern into the crop section 360. Such invalid shapes are pointed out by the dotted circles in FIG. 3D. To solve this problem, a different fill pattern is used instead for the IC device 300.

FIG. 3E shows the different fill pattern, which is symmetric across the line 305. The fill pattern in FIG. 3E has a high uniformity. The fill pattern in FIG. 3E includes fill structures 370 that are on the line 305 and these fill structures 370 are symmetric across the line 305. The fill pattern also includes fill structures 370 that are off the line 305. For each respective fill structure 370 off the line 305, the fill pattern includes another fill structure 370 that is a mirror image of the respective fill structure 370 across the line 305. Accordingly, in the embodiment of FIG. 3B, the fill pattern, the device 320, and the device 330 are all symmetric across the line 305. Accordingly, the mechanical stress and electrical coupling exerted by the fill structures 370 on the devices 320 and 330 can be offset as much as possible. The influence of the fill structures 370 on the devices 320 and 330 are minimized.

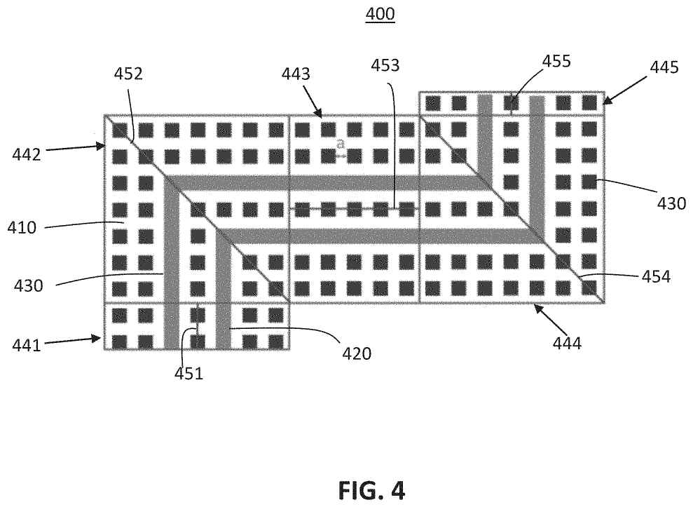

FIG. 4 illustrates an IC device 400 that includes a fill pattern formed based on multiple symmetry axes, according to some embodiments of the disclosure. The IC device 400 includes a support structure 410 and devices 420 and 430. The support structure 410 may be the same as or similar to the support structure 110 in FIGS. 1A-F. The devices 420 and 430 are associated with the support structure 410. The device 420 or 430 may be an embodiment of the device 120 in FIGS. 1A-F. In an example, the devices 420 and 430 are differentially matched devices, e.g., wires, which require a symmetric fill pattern. In other embodiments, the IC device 400 may include fewer, more, or different components.

In the embodiment of FIG. 4, the fill pattern is generated starting from identifying the symmetry axes 451, 452, 453, 454, and 455 of the device 420 or 430. Also, a filling region is identified. The filling region is a region where fill structures can be placed. The filling region can include spaces in the IC device 400 that is not occupied by the devices 420 and 430. To ensure a symmetric filling over the full device, it can be necessary to segregate the filling region in multiple connected filling segments with individual symmetry axes/points and different filling rules. As shown in FIG. 4, the filling region is divided into five segments 441, 442, 443, 444, and 445. The segments 441 and 445 are horizontal segments, the segments 442 and 444 are corner segments, and the segment 443 is a vertical segment. Each segment is then treated as a separate filling segment and filled individually, e.g., by using the method described above in conjunction with FIG. 2D. In some embodiments, different segments can be filled based on different filling rules or different methods.

The total fill pattern for the IC device 400 includes the fill patterns in all the segments 441, 442, 443, 444, and 445. By separating the filling region into segments based on the symmetry axes and filling the segment individually, the total fill pattern for the IC device 400 achieves a high symmetry, leading to an identical (or almost identical) influence of the fill structures on each of the devices 420 and 430.

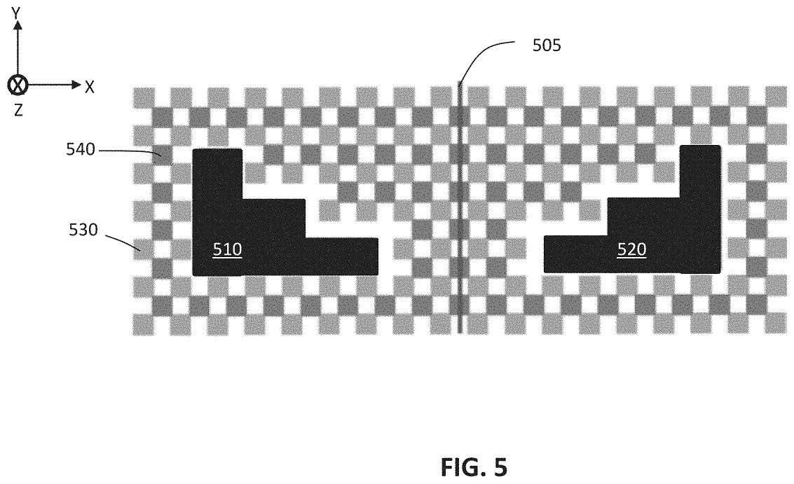

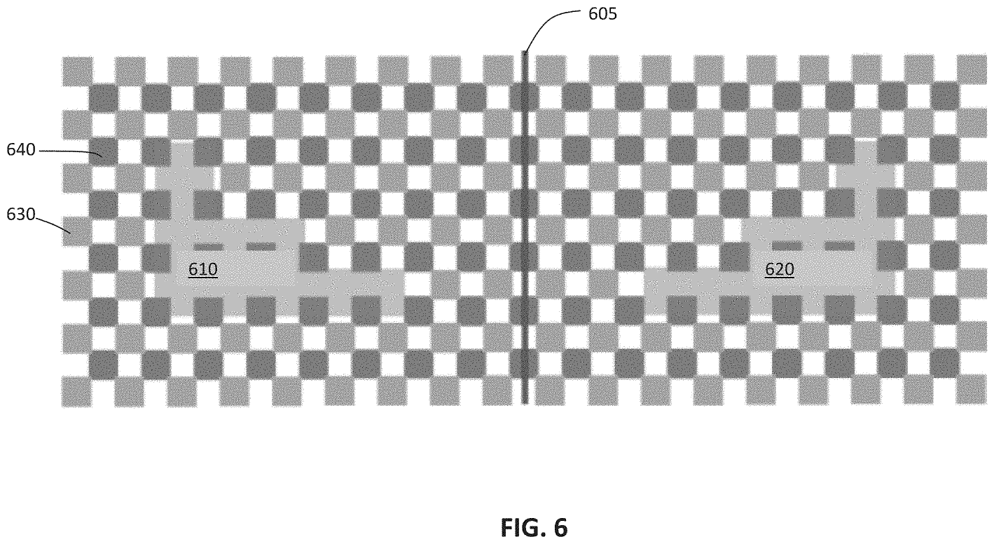

A device can be influence not only by fill structures on the same layer, but also by fill structures on another layer that is either above or below the device. FIGS. 5 and 6 illustrate symmetric arrangements of fill structures in multiple layers, according to some embodiments of the disclosure. FIG. 5 shows two devices 510 and 520 and fill structures 530 and 540. The devices 510 and 520 are on the same layer (“first layer”) as the fill structures 530. The fill structures 540 is in another layer (“second layer”) that is over the first layer. For instance, the first layer is on top of the second layer. The devices 510 and 520 can be influenced by not only the fill structures 530 in the first layer but also the fill structures 540 in the second layer. To minimize the mechanical and electrical influence of the fill structures 530 and 540 on the devices 510 and 520, a line 505, which is defined in the first layer, is carried over to the layer of the fill structures 540. For instance, a line is defined in the second layer based on the line 505 in the first layer so that the line in the second layer is over the line 505. FIG. 5 shows a view of the two layers in the X-Y plane, where the two lines overlap. As both the fill structures 530 and the fill structures 540 are formed based on the line 505, the influence of both the fill structures 530 and the fill structures 540 on the devices 510 and 520 can be minimized.

FIG. 6 shows two devices 610 and 620 and fill structures 630 and 640. The devices 610 and 620 are on the same layer as the fill structures 630. The fill structures 640 is on another layer that is over the layer of the devices 610 and 620. The devices 610 and 620 can be influenced by not only the fill structures 630 but also the fill structures 640. Similar to the embodiment of FIG. 5, a line 605, which is identified in the layer of the devices 610 and 620, is carried over to the layer of the fill structures 640. That way, both the fill structures 630 and the fill structures 640 are formed based on the line 605. Different from the embodiment of FIG. 5, some of the fill structures 640 is over (above or below) the devices 610 and 620. Despite the difference, the embodiment of FIG. 6 also leads to a symmetric arrangements of fill structures over multiple layers. Thus, the influence of both the fill structures 630 and the fill structures 640 on the devices 610 and 620 can be minimized.

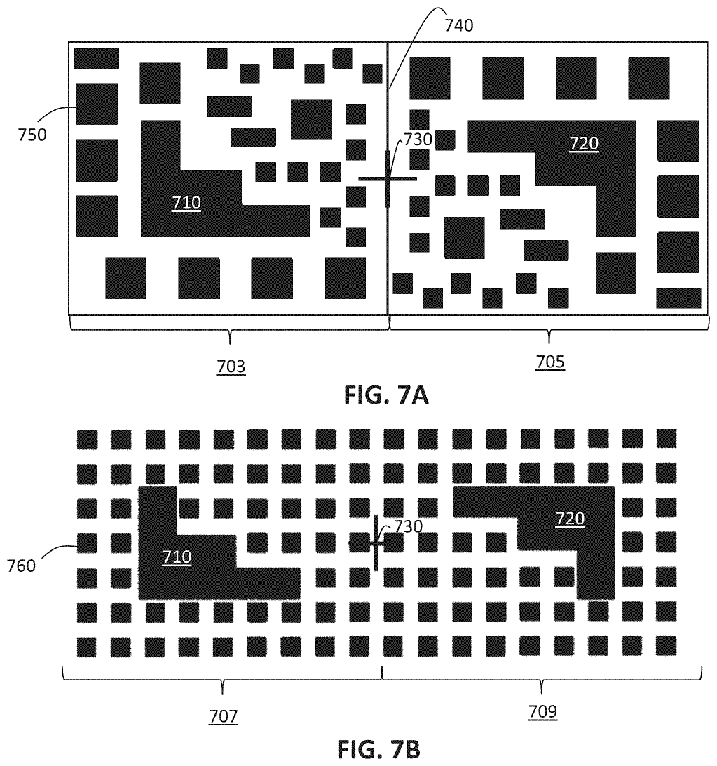

FIGS. 7A and 7B illustrates fill patterns for an IC device having a point symmetric layout, according to some embodiments of the disclosure. The IC device includes two devices 710 and 720. As shown in FIGS. 7A and 7B, the devices 710 and 720 has a point symmetric layout around a point 730. The device 710 is a point reflection of the device 720 through a point 730.

FIG. 7A illustrates a fill pattern that is generated based on a line 740 crossing the point 730. The fill pattern includes fill structures 750 around the devices 710 and 720. The line 740 splits the IC device into two sections 703 and 705. In some embodiments, the angle of the line 740 can be arbitrarily chosen. A fill pattern for one of the sections 703 and 705 (“first fill pattern”) can be generated. Then a fill pattern for the other section (“second fill pattern”) is generated based on the first fill pattern. For instance, the second fill pattern is generated by performing a point wise symmetry operation (e.g., a 180-degree rotation around the point 730) on the first fill pattern.

FIG. 7B illustrates a different fill pattern for the IC device. The fill pattern in FIG. 7B includes fill structures 760 around the devices 710 and 720. Different from the fill pattern in FIG. 7A, the fill pattern in FIG. 7B includes fill structures 760 that are on the line 740 and are symmetric across the line 740. This can avoid formation of invalid shapes. The fill pattern in FIG. 7B can be formed by using stricter fill rules than FIG. 7A. As shown in FIG. 7B, the pattern of the fill structures 760 in the section 707 is identical (or substantially identical) to the pattern of the fill structures 760 in the section 709 is identical. The section 707 corresponds to the section 703 in FIG. 7A, and the section 709 corresponds to the section 705 in FIG. 7A.

In the embodiments shown in the figures described above, the symmetry axes are in the center of the filling region. However, in other embodiments, the symmetry axes might not be in the center of the filling region of an IC device, or an IC device may include filling regions of different sizes.

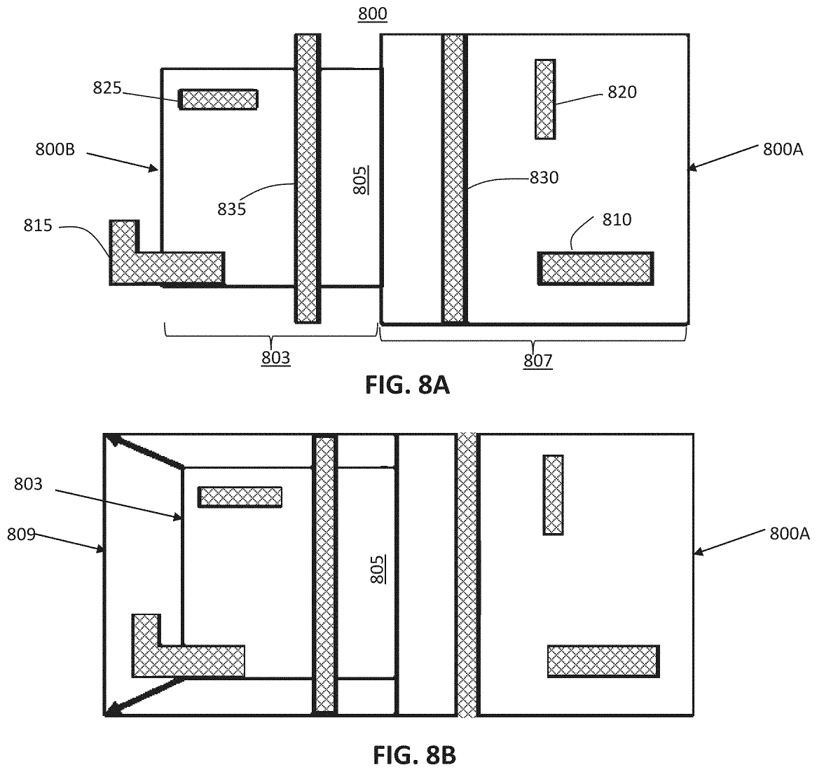

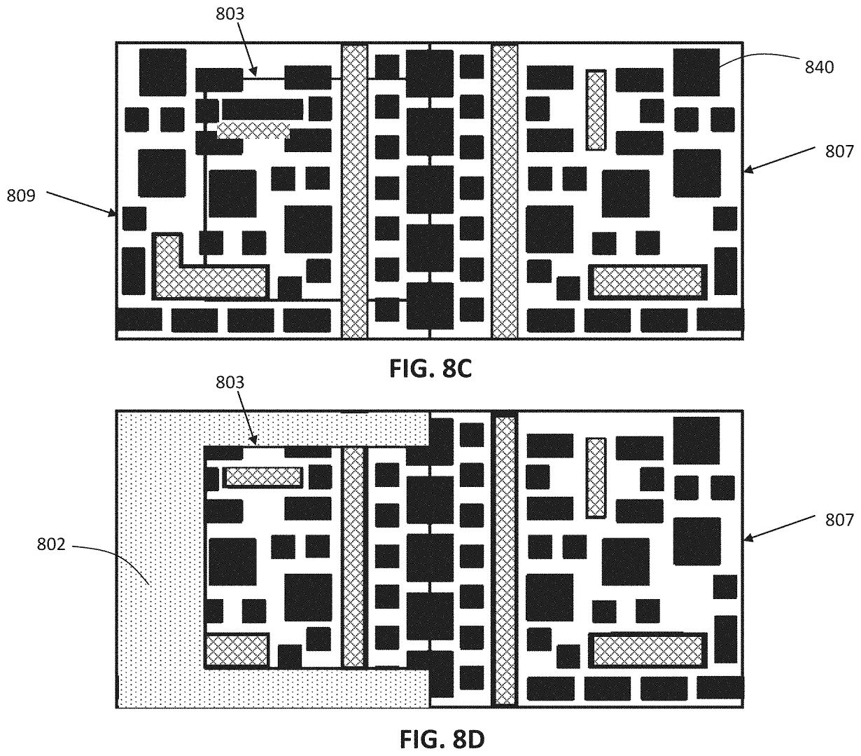

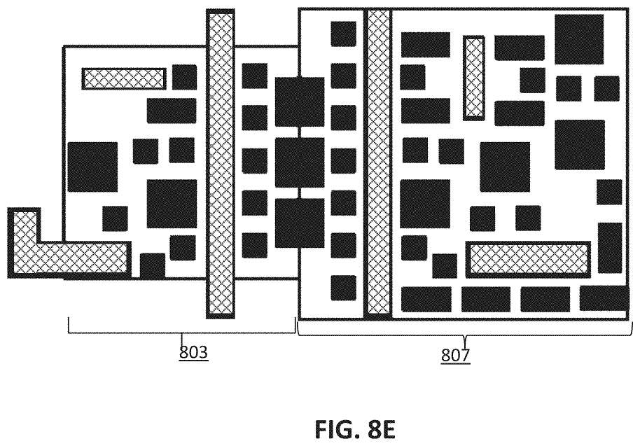

FIGS. 8A-8E illustrate a process of providing a fill pattern for an IC device including filling regions of different sizes, according to some embodiments of the disclosure. FIG. 8A shows an image 800 that represents the IC device. The image 800 includes objects 810, 820, 830, 815, 825, and 835, each of which represents a device in the IC device. In other embodiments, the IC device may include fewer, more, or different devices. A line 805 is defined and divides the image 800 into sections 803 and 807, each of which represent a filling region in the IC device. The section 803 is smaller than the section 807. The line 805 is in the middle of a pair of objects, such as the pair including the objects 830 and 835, the pair including the objects 810 and 815, and the pair including the objects 820 and 825.

In FIG. 8B, the section 803 is enlarged by adding an additional section to the section 803. A section 809 that includes the section 803 and the additional section is generated. The section 809 has a same size as the section 807. In FIG. 8C, a fill pattern is formed, e.g., by using the process described above in conjunction with FIGS. 2A-2F. The fill pattern includes fill structures 840 distributed in both the section 807 and the section 809. Fill structures 840 in a section 802, which is shown in FIG. 8D, are removed to form a new fill pattern, which is shown in FIG. 8E. The section 802 is the additional section that was added to enlarge the section 803. The fill pattern shown in FIG. 8E includes the fill structures 840 in the section 803 and the section 807. The process illustrated in FIGS. 8A-E can also be used to form fill patterns including fill structures with arbitrary sizes or shapes, which can be more complicated than shapes like square or triangle.

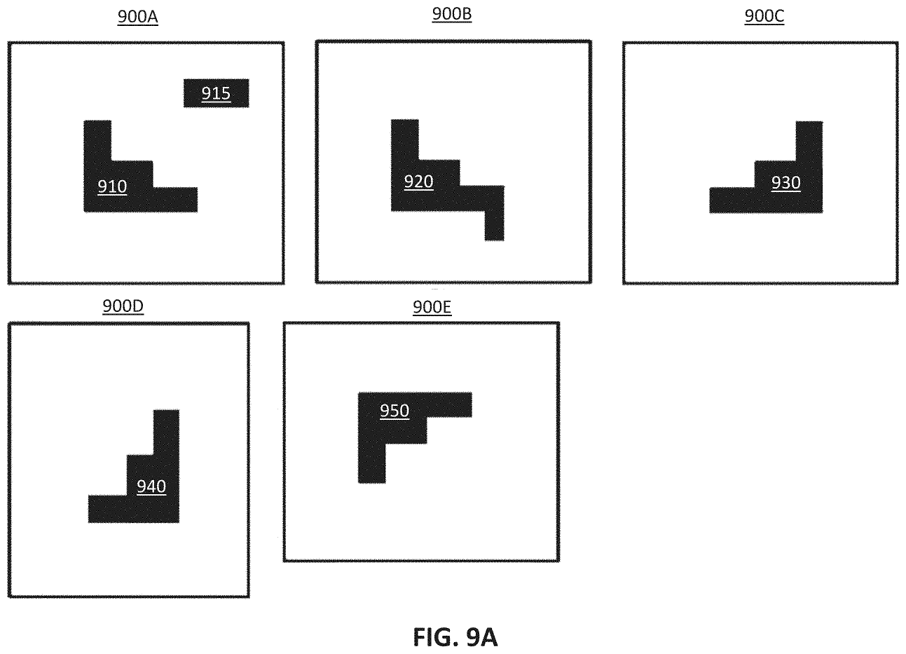

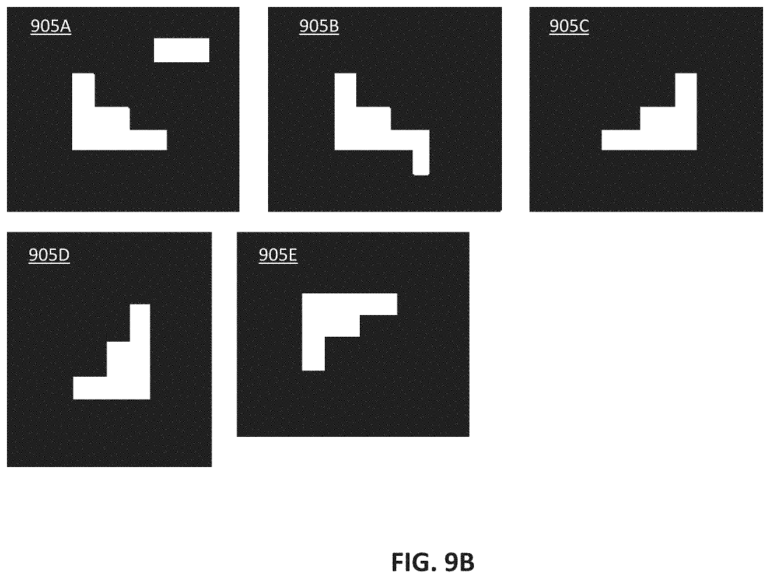

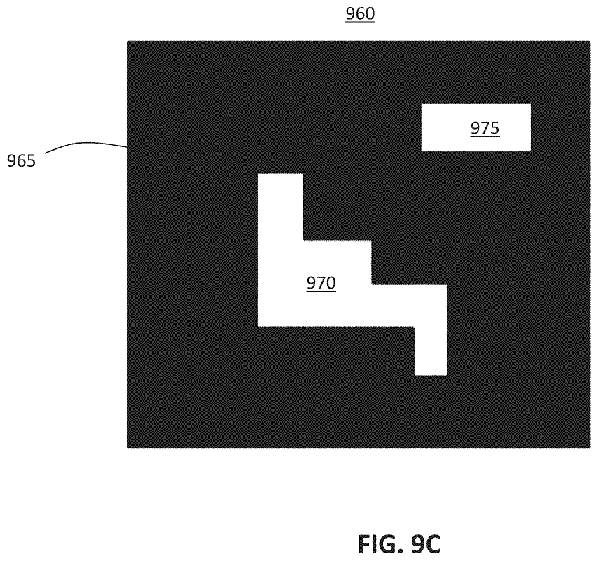

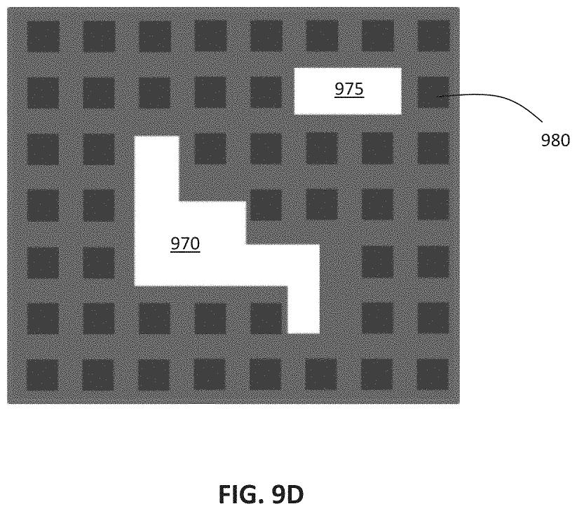

FIGS. 9A-9E illustrates a process of providing a fill pattern by linking filling regions, according to some embodiments of the disclosure. In the embodiment of FIGS. 9A-E, an identical fill pattern is determined for each of the filling regions. FIG. 9A shows five filling regions 900A-E (collectively referred to as “filling regions 900” or “filling region 900”) in an IC device, e.g., a chip. The filling regions 900 may be associated with the same identifier to indicate that they can use the same fill pattern. In some embodiments, the IC device may include other filling regions. For purpose of simplicity and illustration, each filling region 900 is associated with a device. For instance, the filling region 900A includes devices 910 and 915, the filling region 900B includes device 920, the filling region 900C includes device 930, the filling region 900D includes device 940, and the filling region 900E includes device 950. The filling regions 900 are identified as filling regions that can use the same fill pattern and can be considered together. Those regions can be transformed by an arbitrary transform operation including, but not limited to: mirror (arbitrary axis), rotation (arbitrary angle), scaling (arbitrary factor), other types of transform operation, or some combination thereof. Inside the filling regions 900, there are either identical devices (e.g., devices 930, 940, and 950) or devices with a small alternation to the layout (e.g., devices 910 and 920) or even completely different devices (e.g., device 915). The filling of each region may not only be generated with the new uniform approach but applies to all fill patterns in general.

In FIG. 9B, filling spaces 905A-E (collectively referred to as “filling spaces 905” or “filling space 905”) are identified. A filling space 905 is identified in each filling region 900 is identified. A filling space 905 in a filling region 900 is the space that is not occupied by the device(s) in the filling region 900. In FIG. 9C, a merged filling region 960 is generated. In some embodiments, the devices in all the filling regions 900 are transformed into a common coordinate system. Then all transformed fill layers are merged to generate the merged filling region 960. The merged filling region 960 includes structures 970 and 975 and a filling space 965. The structure 970 is generated based on the devices 910, 920, 930, 940, and 950 through transformation and merging. The structure 975 is generated based on the device 915 through direct transformation. In an embodiment, the devices 910, 915, and 920 are directly transformed into the common coordinate system, versus a mirror transformation is performed on the devices 930 and 950, and a 90-degree rotation is performed on the device 940. Then the transformed devices are merged, which forms structures 970 and 975 in the merged filling region 960. The merged filling region 960 has a filling space 965, i.e., the space that is not occupied by the structures 970 and 975. The filling space 965 is the space in the filling region 960 that is not occupied by the structures 970 and 975.

In FIG. 9D, a fill pattern is generated in the filling space 965. For purpose of illustration and simplicity, the fill pattern in FIG. 9C is generated by following stricter fill rules. Also, the fill pattern includes fill structures 980 that all have a square shape and the same size. In other embodiments, the fill pattern may be formed with different fill rules. Also, the fill structures 980 can have different shapes or sizes. In FIG. 9E, the fill pattern generated in FIG. 9D is placed in all the filling regions 900. Also, fill structures 990 are placed in other regions of the IC device. The fill structures 990 can be generated by using various processes, e.g., the process described in FIGS. 1A-1D.

The process illustrated in FIGS. 9A-E ensures an identical fill in the vicinity of the devices for all regions linked together and thereby reduces issues induced by the fill surroundings like electrical coupling or mechanical stress. This approach is not limited to a certain number of linked shapes. The filling regions can be chosen arbitrarily and is not limited to rectangular shapes. Multiples of those filling regions, with different identifiers and arbitrary transforms can exists concurrently in a single layout independently, with different fill rules attached. Moreover, this approach is not limited to a single or certain fill layer and can be applied on any layout layer as outlined in the multilayer extension. The process illustrated in FIGS. 9A-9E may be performed based on an image of the IC device, or images of the filling regions in the IC device, e.g., by a computing device.

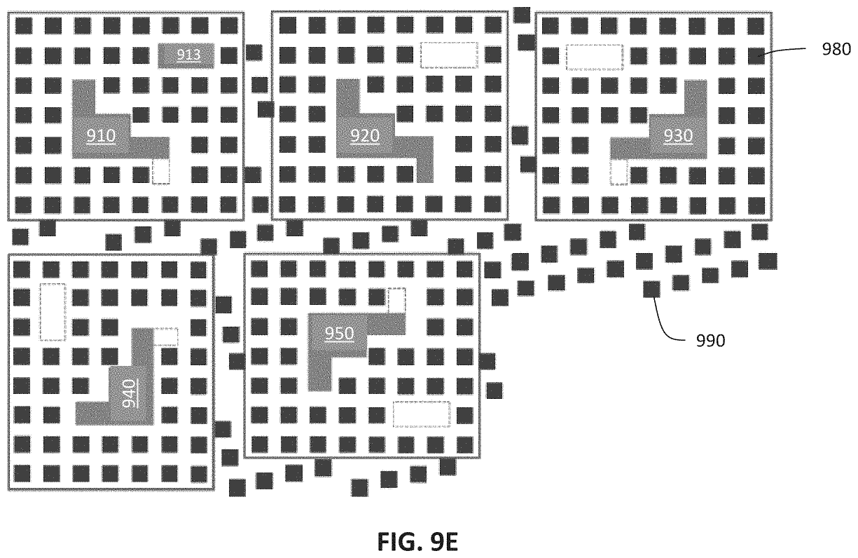

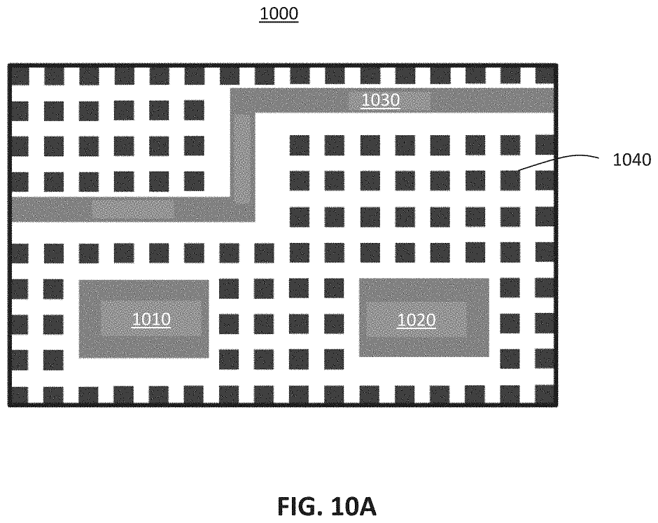

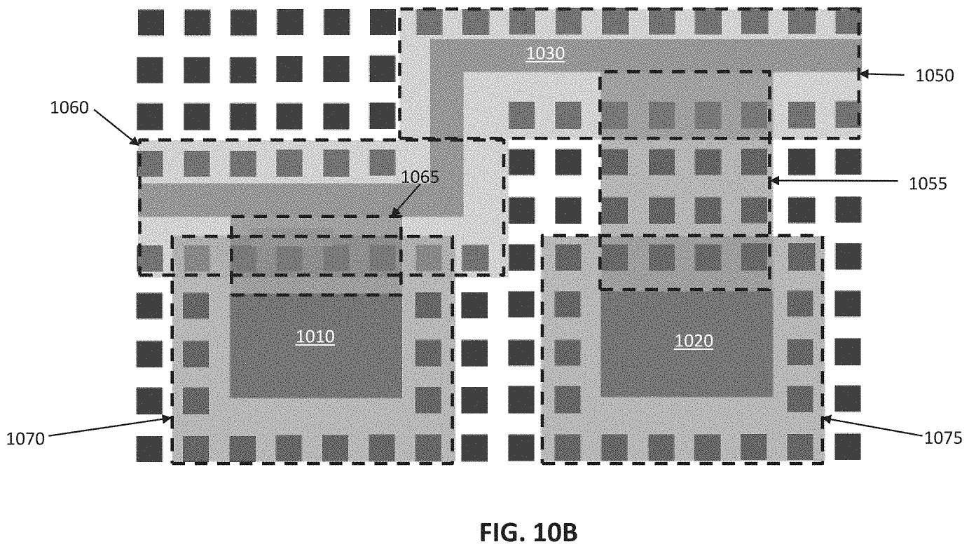

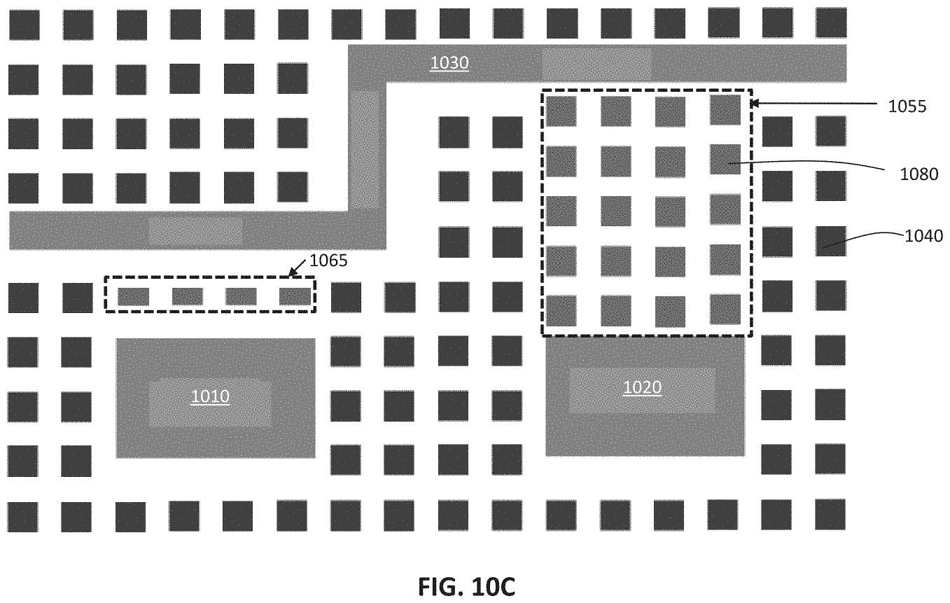

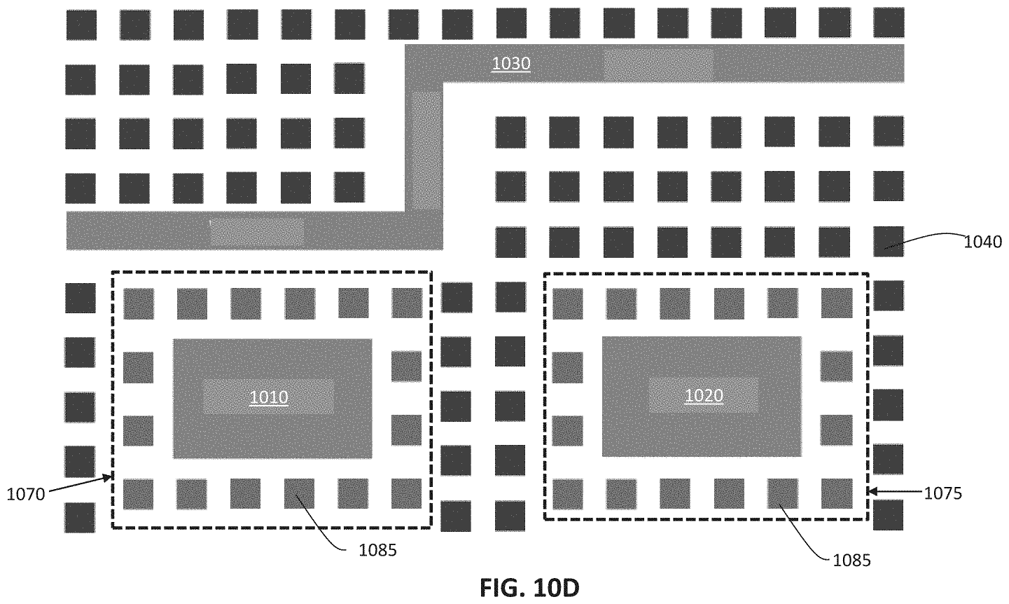

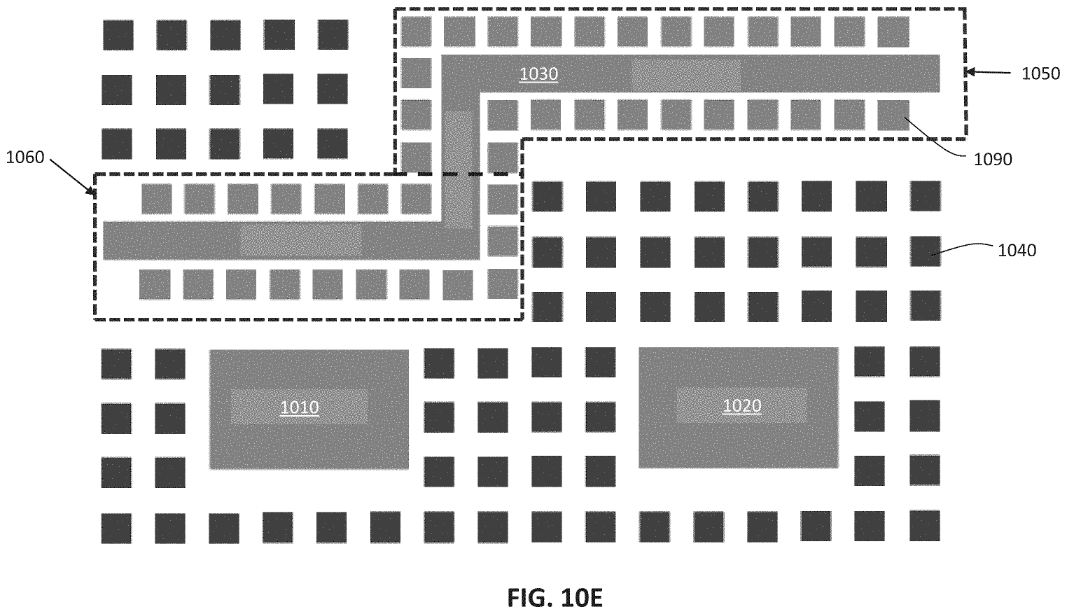

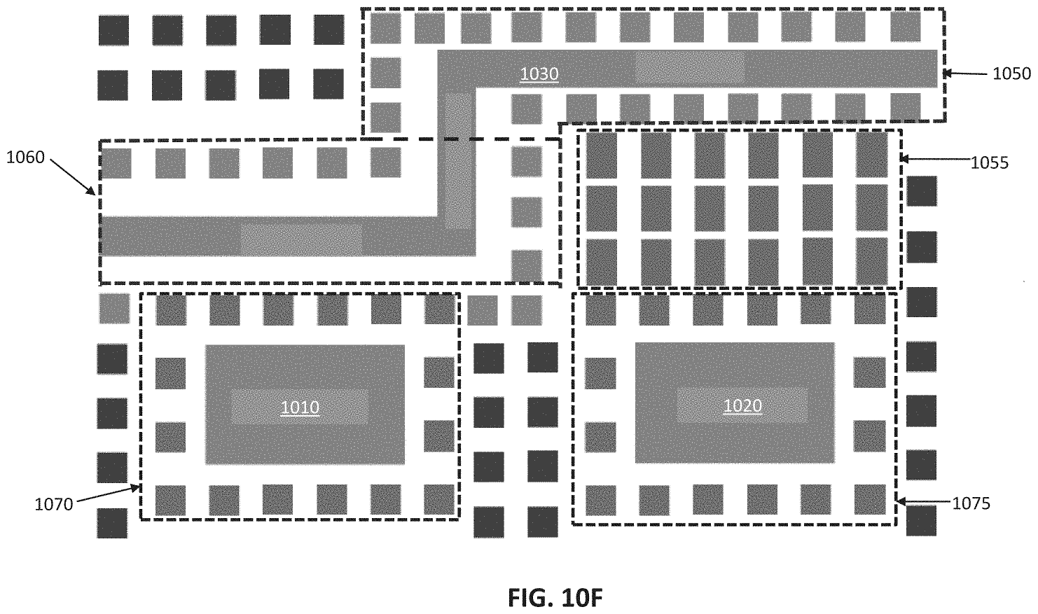

FIGS. 10A-10F illustrates a process of providing a fill pattern for an IC device based on simulation, according to some embodiments of the disclosure. The process allows a reduction of fill influences on the device(s) by a simulation assisted iterative filling procedure. The simulations carried out include but are not limited to electrical simulations, mechanical simulations, and thermal simulations. The process includes analyzing a filled region and iteratively adapting fill rules in accordance to simulation results.

FIG. 10A shows an IC device 1000 that includes devices 1010, 1020, and 1030. The IC device 1000 also includes a fill pattern that comprising fill structures 1040 surrounding the devices 1010, 1020, and 1030. In FIG. 10B, critical regions 1050, 1055, 1060, 1065, 1070, and 1075 are identified in the IC device 1000. A critical region is identified based on simulation. A mechanical simulation can be performed on the IC device 1000 to simulate mechanical stress exerted by the fill structures 1040 on each of the devices 1010, 1020, and 1030. An electrical simulation can also be performed on the IC device 1000 to simulate electrical coupling (e.g., capacitance, inductive coupling, etc.) between the fill structures 1040 and each of the devices 1010, 1020, and 1030. Additionally or alternatively, a thermal simulation or magnetic simulation can be performed to simulate thermal or magnetic coupling between the fill structures 1040 and some or all of the devices 1010, 1020, and 1030.

In some embodiments, the critical regions are identified based on a redefined set of boundary conditions. The predefined boundary conditions include but are not limited to mechanical stress levels at certain regions, electrical coupling between a device and fill structures, electrical coupling between different devices, thermal coupling between a device and fill structures, magnetic coupling between a device and fill structures, etc. In an example, the critical regions 1050 and 1060 are identified on the ground that fill structures 1040 around the device 1030 (i.e., the fill structures 1040 in the critical regions 1050 and 1060) are asymmetric. The critical regions 1055 and 1065 are identified on the ground that the electrical coupling between the devices 1020 and 1030 is different from the electrical coupling between the devices 1010 and 1030. The critical regions 1070 and 1075 are identified on the ground that a stress profile around the devices 1010 and 1020 are uneven.

The fill rules are then adjusted to reduce the influence of the fill structures 1040 in the critical regions. FIG. 10C shows an adjusted fill pattern that is formed by focusing on the critical regions 1055 and 1065. In FIG. 10C, new fill structures 1080 are placed in the critical regions 1055 and 1065. With the new fill structures 1080, the electrical coupling between the devices 1020 and 1030 and the electrical coupling between the devices 1010 and 1030 are equal. The electrical distance between the device 1020 and the device 1030 has been reduced by adding additional conductive filling shapes. Whereas the electrical distance between the device 1010 and the device 1030 has been increased by shrinking the fill structures. FIG. 10D shows an adjusted fill pattern that is formed by focusing on critical regions 1070 and 1075. In FIG. 10D, the fill structures 1085 around the devices 1010 and 1020 are spread out evenly resulting in an even stress contribution from all sides. FIG. 10E shows an adjusted fill pattern that is formed by focusing on critical regions 1050 and 1060. In FIG. 10E, the fill structures 1090 around the device 1030 forms a fill pattern that is symmetric with regard to the center axis of the device 1030.

However, it is possible that a fill rule may benefit one critical region but impair another critical region. For instance, a fill rule may reduce the influence of the fill structures 1040 in one critical region but increases the influence of the fill structures 1040 in another critical region. In some embodiments, a weight is determined for a boundary condition, e.g., based on the importance of the boundary condition to the performance of one or more devices or the performance of the IC device 1000 as a whole. A boundary condition having a higher weight is given a higher priority and fill rules that address the boundary condition will trump fill rules that address another boundary condition that has a lower weight.

FIG. 10F shows a fill pattern that is formed based on an optimization for all the critical regions 1050, 1055, 1060, 1065, 1070, and 1075. In some embodiments, the optimized fill pattern is formed based on the fill patterns in FIGS. 10C-E and weights of the boundary conditions. In an example where the stress boundary condition has the highest weight, the symmetry boundary condition boundary condition has the second highest weight, and the electrical boundary condition has the lowest weight, the stress fix is given the highest priority, with the symmetry fix coming in second and the electrical fix last. For the symmetry boundary condition, the fill rules is relaxed in the vicinity of the device 1010, however this can be compensated by adjusting the fill structures on the opposite side of the device 1030. The electrical fix for the device 1020 is readjusted for better matching of the electrical coupling between the devices 1020 and 1030 and the electrical coupling between the devices 1010 and 1030.

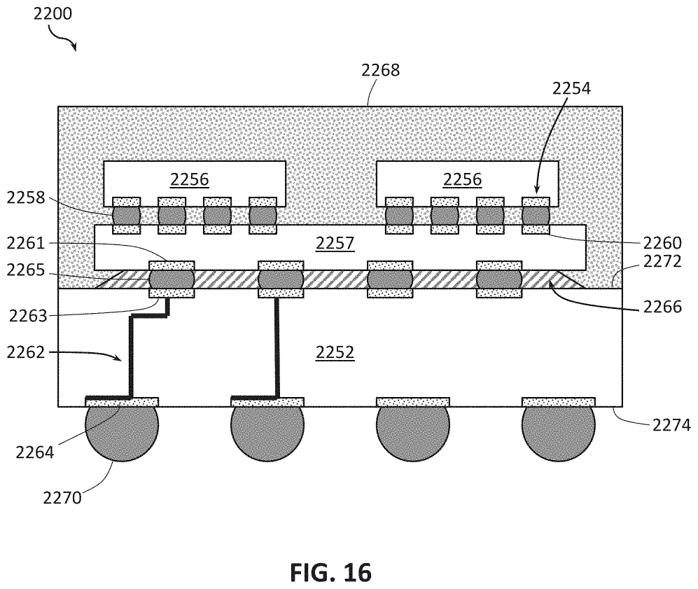

In some embodiments, the process illustrated in FIGS. 10B-F can be iterated until a certain confidence threshold is reached. The confidence threshold may be a threshold for one or more boundary conditions. More details regarding the process are described below in conjunction with FIG. 16. FIGS. 10A-F shows a horizontal adjustment of a fill pattern, i.e., adjustment of the fill pattern in one layer. In other embodiments, fill patterns on multiple layers can be adjusted based on simulation. Such adjustments are vertical adjustments. The process illustrated in FIGS. 10A-10F may be performed based on an image of the IC device, e.g., by a computing device.

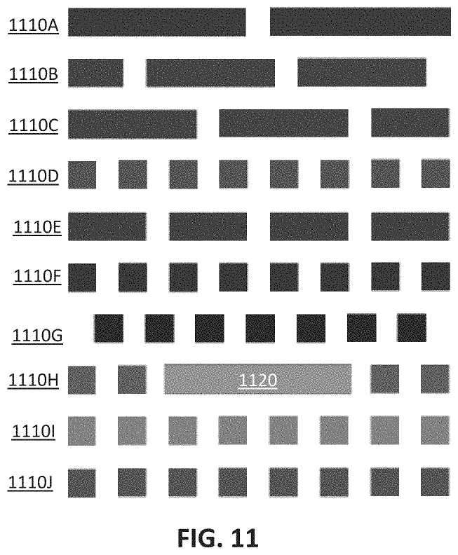

FIG. 11 illustrates vertical adjustment of a fill pattern, according to some embodiments of the disclosure. FIG. 11 shows 10 layers 1110A-J (collectively referred to as “layers 1110” or “layer 1110”) that are over each other. A device 1120 is in the layer 1110H. Each layer 1110 can have a fill pattern that is generated based on a set of fill rules applied to the whole layer 1110 or subsections of the layer 1110. Different sets of fill rules can be applied to different layers 1110, resulting in different fill patterns. The fill pattern in a layer 1110 may influence a device in a different layer. For instance, stress induced by large fill structures in the layer 1110E can impact the device 1120 in the layer 1110H and degrade the performance of the device 1120. Such influence can be mitigated or reduced by creating a compensation pattern on a different layer to even out or reduce the stress in the device 1120. For example, an artificial compensation pattern can be added on the layer 1110D to compensate the stress caused by the fill structures in the layer 1110E and to improve performance of the device 1120.

In some embodiments, a process of adjusting fill patterns includes both horizontal adjustment and vertical adjustment. In some embodiments, an initial fill pattern is formed on each layer. Next, critical regions are identified through simulation based on boundary conditions. Further, fill rules are adjusted based on each boundary conditions. Then the adjusted fill rules are optimized based on weights of the boundary conditions. One or more layers are refilled with the optimized fill rules. The steps of identifying critical region, adjusting fill rules, and optimizing fill rules can be iterated until a certain confidence threshold is reached.

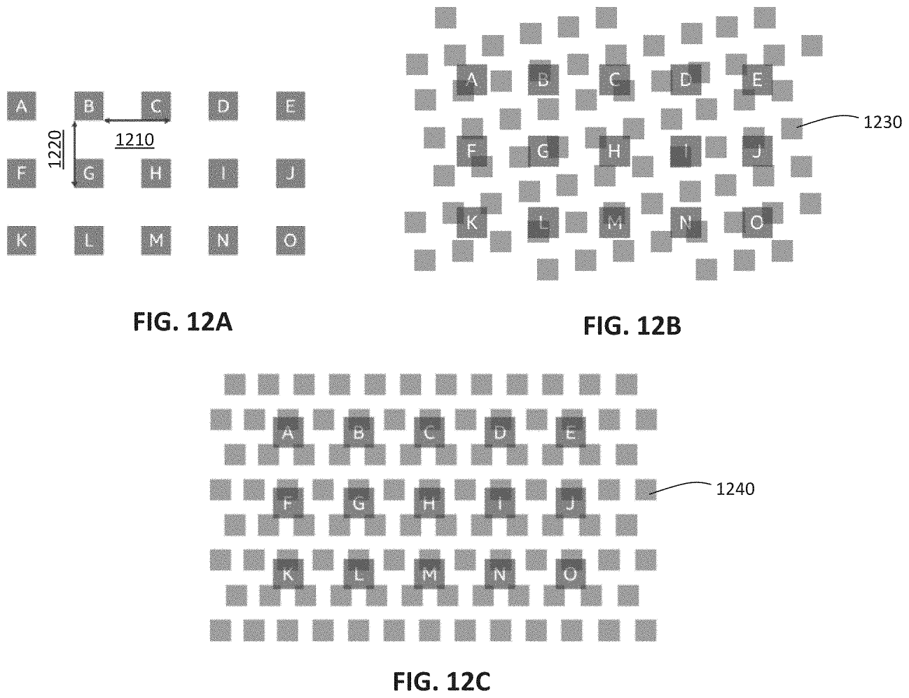

FIGS. 12A-12C illustrates providing a fill pattern based on device pitches, according to some embodiments of the disclosure. Fill pitch is the distance between two adjacent fill structures. Adjacent fill structures are fill structures placed right next to each other. Some devices, e.g., arrays of matched transistors, suffer from stress or electrical coupling induced by fill structures on different layers or on the same layer. These fill influences can impede the performance of different devices in different ways, which results in bad performance of the matched device array or failure. A boundary condition can be imposed on the fill with large stress impact in a way to symmetrize it over the matched array. This can be done by adjusting the fill structure size and shape as well as determining the fill structure pitch based on the array pitch. For instance, the fill pitch may equal the array pitch, two times of the array pitch, or a different number of times of the array pitch.

In FIG. 12A, 15 devices A-O are depicted on an exemplary rectangular grid for purpose of illustration. The devices are spaced with a pitch 1210 and a pitch 1220. A pitch is a distance between two adjacent devices. The two pitches 1210 and 1220 are along orthogonal directions. FIG. 12B shows a filling procedure that focuses on one layer but does not count in the arrangement of the devices in a different layer. The filling procedure forms a fill pattern comprising a plurality of fill structures 1230 (individually referred to as “fill structure 1230”). The fill structures 1230 influence different devices differently. Each device can suffer from a different influence of the fill pattern and a different degree of performance degradation, which can result in a failure of the array.

FIG. 12C provides a solution to the problem. FIG. 12C shows a fill pattern including fill structures 1240 (individually referred to as “fill structure 1240”). In FIG. 12C, a boundary condition is imposed on the fill pattern to follow the pitches of the devices and therefore, match the fill pattern to the pattern of the devices. In FIG. 12C, all the devices have the same fill surrounding. In other words, the pattern of the fill structures 1210 surrounding each device is the same. Accordingly, the influence of the fill pattern on the devices are the same. Even though an individual device is still influenced by the fill structures 1210, the degrees of their performance degradation are the same, which can avoid the failure of the matched array.

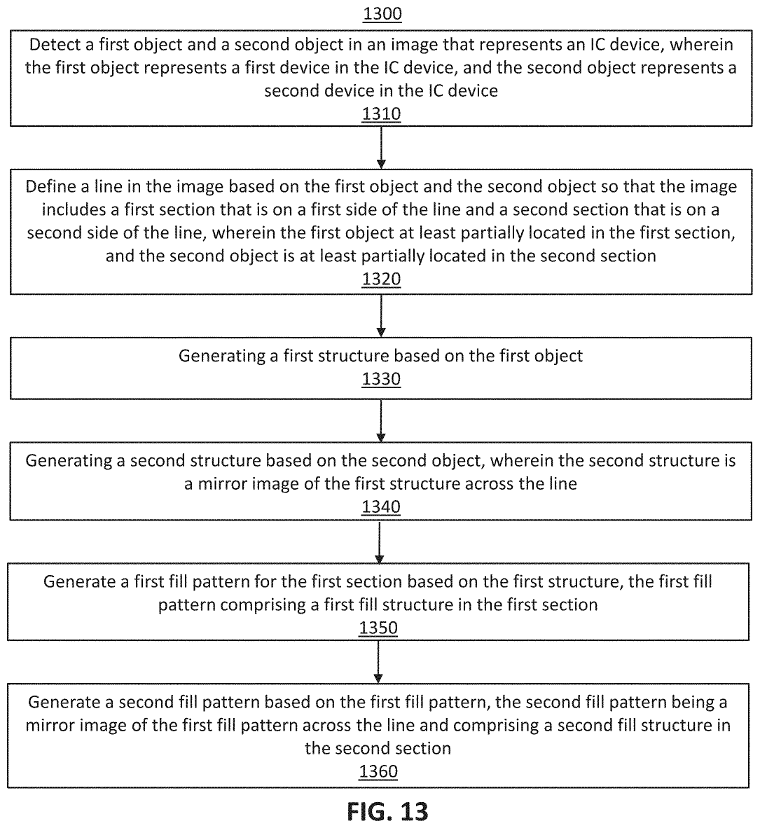

FIG. 13 is a flowchart showing a method 1300 of providing a fill pattern for an IC device, in accordance with various embodiments. The method 1300 may be performed by the computing device 2400 in FIG. 20, e.g., by the processing device 2402. In some embodiments, the method 1300 includes instructions that are stored in one or more non-transitory computer-readable media and are executable, e.g., by a processing device. Although the method 1300 is described with reference to the flowchart illustrated in FIG. 13, many other methods for providing fill patterns for IC devices may alternatively be used. For example, the order of execution of the steps in FIG. 13 may be changed. As another example, some of the steps may be changed, eliminated, or combined.

The method 1300 includes detecting 1310 a first object and a second object in an image. The image represents the IC device. The first object represents a first device in the IC device. The second object represents a second device in the IC device. The image may be two-dimensional or three-dimensional. In some embodiments, the image is a virtual representation of the IC device that is generated by a computing device. The image can include other objects that represent other components of the IC devices, such as other devices, a support structure associated with one or more devices in the IC device, layers in the IC device, etc.

A device (e.g., the first device or the second device) can be a functional component of the IC device. A device may perform an electronic function in the IC device. In some embodiments, a device is an electronic component, such as a transistor, capacitor, resistor, power rail, wire, bus, and so on. In other embodiments, a device includes a collection of multiple electronic components, such as an amplifier, oscillator, timer, microprocessor, memory, and so on.

The method 1300 further includes defining 1320 a line in the image based on the first object and the second object. The line may be defined by identifying a symmetry axis or symmetry point of the IC device. The line can be the symmetry axis or a line crossing the symmetry point. In some embodiments, the line is in the middle of a pair of devices in the IC device. For instance, the line is in the middle of at least a portion of the first object and at least a portion of the second object. The IC device comprises a first section that is on a first side of the line and a second section that is on a second side of the line. The second side is opposite the first side. The first object at least partially located in a first section, and the second object at least partially located in the second section. An example of the line is the line 215, 505, 605, 740, or 805.

The method 1300 further includes generating 1330 a first structure based on the first object and generating 1340 a second structure based on the second object. The first structure is a mirror image of the second structure across the line. The first structure may have the same (or substantially same) location as the first object in the first section. The second structure may have the same (or substantially same) location as the second object in the second section. In some embodiments, a structure is generated by transforming an object, merging multiple objects, or both. A transformation may be a direct transformation (e.g., moving or copying), a reflection transformation (e.g., across the line), a rotational transformation (e.g., around a predetermined angle), etc.

In an example, the first structure is the structure 230A, which is transformed from the object 220A, and the second structure is the structure 230A′, which is transformed from the object 220A′. The structure 230A is formed by merging a structure that is copied from the object 220A with a mirror image of the object 220A′ across the line 215. The structure 230A′ is copied from the object 220A′. The structure 230A is a mirror image of the structure 230A′. In another example, the first structure is the structure 230B, which is transformed from the object 220B, and the second structure is the structure 230B′, which is transformed from the object 220B′. The structure 230B is formed by merging the structure 2256, which is copied from the object 220B, with the structure 2256′, which is formed through a reflection transformation of the object 220B′. The structure 230B′ is a mirror image of the structure 230B. In yet another example, the first structure is the structure 230C, which is transformed from the object 220C, and the second structure is the structure 230C′, which is transformed from the object 220C′. The structure 230C is formed by copying the object 220C. The structure 230C is formed by copying the object 220C′. The structure 230C′ is a mirror image of the structure 230C.

The method 1300 further includes generating 1350 a first fill pattern for the first section based on the first structure. The first fill pattern comprises a first fill structure in the first section. In some embodiments, the first section is selected over the second section as the source section. For instance, a third fill pattern is generated for the second section based at least on the second structure. The third fill pattern includes at least one third fill structure in the second section. A first region of interest is identified in the first section. A second region of interest is identified in the second section. The first region of interest may be a mirror image of the second region of interest across the line 215. A quality of the first fill structures in the first region of interest is compared with a corresponding quality of the third fill structures in the second region of interest. The first section is selected over the second section based on a determination that the quality of the first fill structures in the first region of interest is better than the quality of the third fill structures in the second region of interest. The quality may be distance(s) of the fill structures to the first or second object, coupling (e.g., electrical, mechanical, magnetic, or thermal coupling) between fill structures and the first or second object, mechanical stress exerted by the fill structures on the first or second object, size(s) of the fill structures, other types of qualities, or some combination thereof.

The method 1300 also includes generating 1350 a second fill pattern based on the first fill pattern. In some embodiments, the second fill pattern is generated by performing a transformation, e.g., a reflection transformation across the line, on the first fill pattern. The second fill pattern is a mirror image of the first fill pattern across the line and comprises at least one second fill structure in the second section. The first fill pattern and the second fill pattern represent patterns of fill structures to be included in the IC device.

In some embodiments, the first section has a same dimension or size as the second section. In other embodiments, it is determined that the second section has a smaller size than the first section. Based on such a determination, a third section is generated by adding a fourth section to the second section so that the third section has the same size as the first section. The first fill pattern is transformed to a third fill pattern for the third section. A portion of the third fill pattern (e.g., the fill structures in the fourth section) is removed to form the second fill pattern.

In some embodiments, multiple lines are defined in the image. For instance, a different line is defined, e.g., based on the first object and the second object, so that the image includes a third section and a fourth section. At least a portion of the first object is in the third section. At least a portion of the second object is in the fourth section. Then a third fill pattern is generated. The third fill pattern includes a third fill structure in the third section. Also, a fourth fill pattern is generated by transforming the third fill pattern. The fourth fill pattern can be a mirror image of the third fill pattern across the different line. The fourth fill pattern comprises a fourth fill structure in the fourth section.

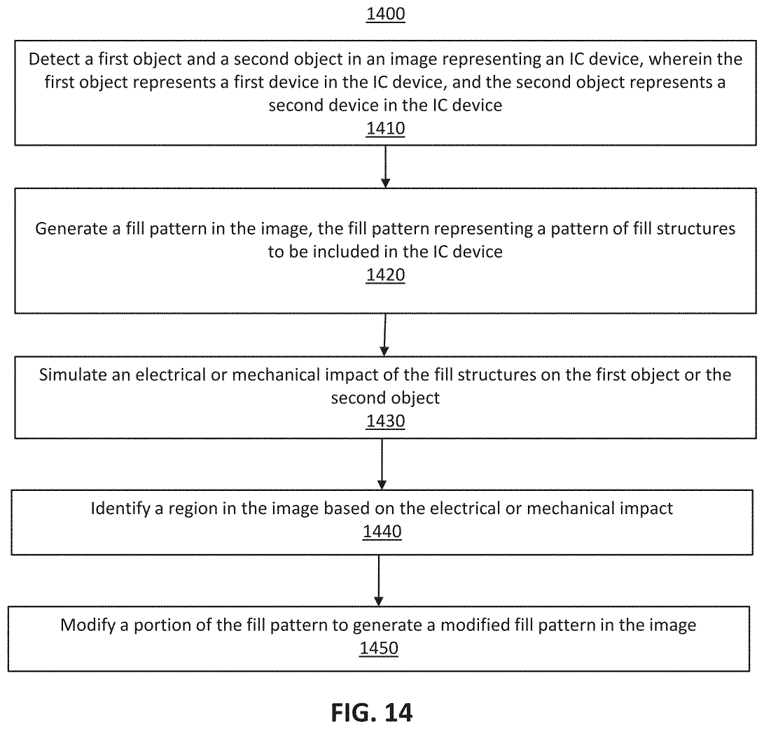

FIG. 14 is a flowchart showing another method 1400 of providing a fill pattern for an IC device, in accordance with various embodiments. The method 1400 may be performed by the computing device 2400 in FIG. 20, e.g., by the processing device 2402. In some embodiments, the method 1400 includes instructions that are stored in one or more non-transitory computer-readable media and are executable, e.g., by a processing device. Although the method 1400 is described with reference to the flowchart illustrated in FIG. 14, many other methods for providing fill patterns for IC devices may alternatively be used. For example, the order of execution of the steps in FIG. 14 may be changed. As another example, some of the steps may be changed, eliminated, or combined.

The method 1400 includes detecting 1410 a first object and a second object in an image. The image represents the IC device. The first object represents a first device in the IC device. The second object represents a second device in the IC device. The image may be two-dimensional or three-dimensional. In some embodiments, the image is a virtual representation of the IC device that is generated by a computing device. The image can include other objects that represent other components of the IC devices, such as other devices, a support structure associated with one or more devices in the IC device, layers in the IC device, etc.

A device (e.g., the first device or the second device) can be a functional component of the IC device. A device may perform an electronic function in the IC device. In some embodiments, a device is an electronic component, such as a transistor, capacitor, resistor, power rail, wire, bus, and so on. In other embodiments, a device includes a collection of multiple electronic components, such as an amplifier, oscillator, timer, microprocessor, memory, and so on.

The method 1400 further includes generates 1420 a fill pattern in the image. The fill pattern represents a pattern of fill structures to be included in the IC device. The fill structures, after included in the IC device, may surround at least a portion of the first object and at least a portion of the second object. A fill structure may be a non-function structure that is included in the IC device to facilitate fabrication of the IC device. The fill structures may have various shapes, sizes, or materials.

The method 1400 further includes simulating 1430 an electrical or mechanical impact of the fill structures on the first device or the second device, e.g., by performing an electrical or mechanical simulation based on the image. In an example, a first mechanical stress applied by at least some of the fill structures on the first device is simulated. Also, a second mechanical stress applied by at least some of the fill structures on the second device is simulated. Further, it is determined whether the first mechanical stress matches (e.g., equals, or substantially similar) the second mechanical stress. In another example, a first capacitance between the first device and a third device is simulated. And a second capacitance between the second device and the third device is simulated. Then it is determined whether the first capacitance matches (e.g., equals, or substantially similar) the second capacitance. Alternative to or in additional to simulating the electrical or mechanical impact, it is determined whether fill structures around the first device or the second device has a symmetric layout.

The method 1400 further includes identifying 1440 a region in the image based on the electrical or mechanical impact. In some embodiments, the region is a region that meets a boundary condition. The boundary condition may be mechanical, electrical, or structural. The method 1400 also includes modifying 1450 a portion of the fill pattern to generate a modified fill pattern in the image. The portion is in the region. The modified fill pattern represents a pattern of modified fill patterns to be included in the IC device. A simulated electrical or mechanical impact of the modified fill pattern on the first device or the second device is less than the electrical or mechanical impact of the fill pattern on the first device or the second device.

In some embodiments, multiple regions are identified and each region may be identified based on a different boundary condition. In such embodiments, the modification for addressing a region, even though improves the boundary condition of the region, may make the boundary condition of a different region worse. For situations like this, each boundary condition may be assigned a weight. The weight may also be a weight of the corresponding region. Each region is modified separately. Then the whole fill pattern is optimized based on the weights of the boundary conditions. For instance, a boundary condition having a higher weight is given a higher priority in the optimization process.

In some embodiments, the modification is performed on one layer of the IC device. In other embodiments, the modification is performed on multiple layers of the IC devices. For instance, another fill pattern on a different layer (e.g., a layer over the first object, the second object, and the fill pattern) is located can be modified to reduce the electrical or mechanical impact of the fill pattern on the first object or the second object.

FIGS. 15A-15B are top views of a wafer 2000 and dies 2002 that may include fill structures, according to some embodiments of the disclosure. In some embodiments, the dies 2002 may be included in an IC package, according to some embodiments of the disclosure. For example, any of the dies 2002 may serve as any of the dies 2256 in an IC package 2200 shown in FIG. 16. The wafer 2000 may be composed of semiconductor material and may include one or more dies 2002 having IC devices formed on a surface of the wafer 2000. Each of the dies 2002 may be a repeating unit of a semiconductor product that includes any suitable IC (e.g., ICs including fill structures as described herein). After the fabrication of the semiconductor product is complete, the wafer 2000 may undergo a singulation process in which each of the dies 2002 is separated from one another to provide discrete “chips” of the semiconductor product. In particular, devices that include fill structures as disclosed herein may take the form of the wafer 2000 (e.g., not singulated) or the form of the die 2002 (e.g., singulated). The die 2002 may include one or more diodes, one or more transistors (e.g., one or more III-N transistors as described herein) as well as, optionally, supporting circuitry to route electrical signals to the III-N diodes with n-doped wells and capping layers and III-N transistors, as well as any other IC components. In some embodiments, the wafer 2000 or the die 2002 may implement an electrostatic discharge (ESD) protection device, an RF FE device, a memory device (e.g., a static random-access memory (SRAM) device), a logic device (e.g., an AND, OR, NAND, or NOR gate), or any other suitable circuit element. Multiple ones of these devices may be combined on a single die 2002.

FIG. 16 is a side, cross-sectional view of an example IC package 2200 that may include one or more IC devices having fill structures, according to some embodiments of the disclosure. In some embodiments, the IC package 2200 may be a system-in-package (SiP).

As shown in FIG. 16, the IC package 2200 may include a package substrate 2252. The package substrate 2252 may be formed of a dielectric material (e.g., a ceramic, a glass, a combination of organic and inorganic materials, a buildup film, an epoxy film having filler particles therein, etc., and may have embedded portions having different materials), and may have conductive pathways extending through the dielectric material between the face 2272 and the face 2274, or between different locations on the face 2272, and/or between different locations on the face 2274.

The package substrate 2252 may include conductive contacts 2263 that are coupled to conductive pathways 2262 through the package substrate 2252, allowing circuitry within the dies 2256 and/or the interposer 2257 to electrically couple to various ones of the conductive contacts 2264 (or to other devices included in the package substrate 2252, not shown).

The IC package 2200 may include an interposer 2257 coupled to the package substrate 2252 via conductive contacts 2261 of the interposer 2257, first-level interconnects 2265, and the conductive contacts 2263 of the package substrate 2252. The first-level interconnects 2265 illustrated in FIG. 16 are solder bumps, but any suitable first-level interconnects 2265 may be used. In some embodiments, no interposer 2257 may be included in the IC package 2200; instead, the dies 2256 may be coupled directly to the conductive contacts 2263 at the face 2272 by first-level interconnects 2265.

The IC package 2200 may include one or more dies 2256 coupled to the interposer 2257 via conductive contacts 2254 of the dies 2256, first-level interconnects 2258, and conductive contacts 2260 of the interposer 2257. The conductive contacts 2260 may be coupled to conductive pathways (not shown) through the interposer 2257, allowing circuitry within the dies 2256 to electrically couple to various ones of the conductive contacts 2261 (or to other devices included in the interposer 2257, not shown). The first-level interconnects 2258 illustrated in FIG. 16 are solder bumps, but any suitable first-level interconnects 2258 may be used. As used herein, a “conductive contact” may refer to a portion of electrically conductive material (e.g., metal) serving as an interface between different components; conductive contacts may be recessed in, flush with, or extending away from a surface of a component, and may take any suitable form (e.g., a conductive pad or socket).

In some embodiments, an underfill material 2266 may be disposed between the package substrate 2252 and the interposer 2257 around the first-level interconnects 2265, and a mold compound 2268 may be disposed around the dies 2256 and the interposer 2257 and in contact with the package substrate 2252. In some embodiments, the underfill material 2266 may be the same as the mold compound 2268. Example materials that may be used for the underfill material 2266 and the mold compound 2268 are epoxy mold materials, as suitable. Second-level interconnects 2270 may be coupled to the conductive contacts 2264. The second-level interconnects 2270 illustrated in FIG. 16 are solder balls (e.g., for a ball grid array arrangement), but any suitable second-level interconnects 22770 may be used (e.g., pins in a pin grid array arrangement or lands in a land grid array arrangement). The second-level interconnects 2270 may be used to couple the IC package 2200 to another component, such as a circuit board (e.g., a motherboard), an interposer, or another IC package, as known in the art and as discussed below with reference to FIG. 15.

The dies 2256 may take the form of any of the embodiments of the die 2002 discussed herein and may include any of the embodiments of an IC device having fill structures. In embodiments in which the IC package 2200 includes multiple dies 2256, the IC package 2200 may be referred to as a multi-chip package. Importantly, even in such embodiments of a multi-chip package (MCP) implementation of the IC package 2200, fill structures may be provided in a single chip, in accordance with any of the embodiments described herein. The dies 2256 may include circuitry to perform any desired functionality. For example, one or more of the dies 2256 may be ESD protection dies, including fill structures as described herein, one or more of the dies 2256 may be logic dies (e.g., silicon-based dies), one or more of the dies 2256 may be memory dies (e.g., high bandwidth memory), etc. In some embodiments, any of the dies 2256 may include fill structures, e.g., as discussed above; in some embodiments, at least some of the dies 2256 may not include any III-N diodes with n-doped wells and capping layers.

The IC package 2200 illustrated in FIG. 16 may be a flip chip package, although other package architectures may be used. For example, the IC package 2200 may be a ball grid array (BGA) package, such as an embedded wafer-level ball grid array (eWLB) package. In another example, the IC package 2200 may be a wafer-level chip scale package (WLCSP) or a panel fan-out (FO) package. Although two dies 2256 are illustrated in the IC package 2200 of FIG. 16, an IC package 2200 may include any desired number of the dies 2256. An IC package 2200 may include additional passive components, such as surface-mount resistors, capacitors, and inductors disposed on the first face 2272 or the second face 2274 of the package substrate 2252, or on either face of the interposer 2257. More generally, an IC package 2200 may include any other active or passive components known in the art.

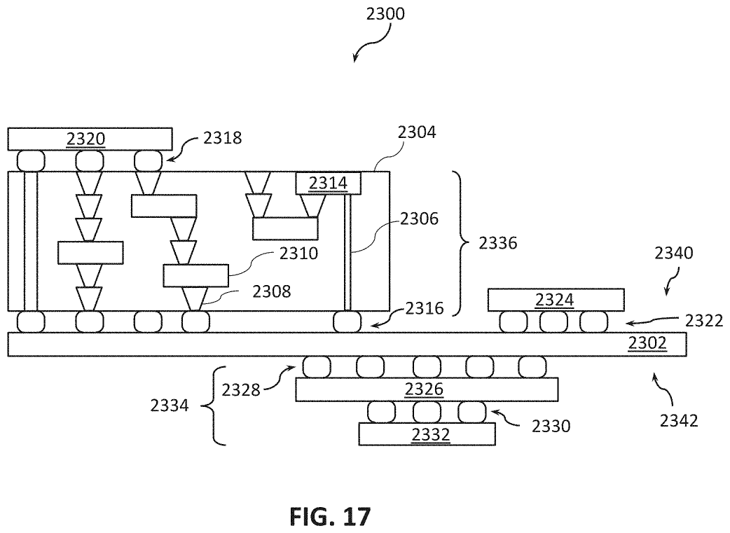

FIG. 17 is a cross-sectional side view of an IC device assembly 2300 that may include components having one or more IC devices implementing fill structures, according to some embodiments of the disclosure. The IC device assembly 2300 includes a number of components disposed on a circuit board 2302 (which may be, e.g., a motherboard). The IC device assembly 2300 includes components disposed on a first face 2340 of the circuit board 2302 and an opposing second face 2342 of the circuit board 2302; generally, components may be disposed on one or both faces 2340 and 2342. In particular, any suitable ones of the components of the IC device assembly 2300 may include any of the IC devices implementing fill structures in accordance with any of the embodiments disclosed herein; e.g., any of the IC packages discussed below with reference to the IC device assembly 2300 may take the form of any of the embodiments of the IC package 2200 discussed above with reference to FIG. 14 (e.g., may include fill structures in/on a die 2256).

In some embodiments, the circuit board 2302 may be a PCB including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 2302. In other embodiments, the circuit board 2302 may be a non-PCB substrate.

The IC device assembly 2300 illustrated in FIG. 17 includes a package-on-interposer structure 2336 coupled to the first face 2340 of the circuit board 2302 by coupling components 2316. The coupling components 2316 may electrically and mechanically couple the package-on-interposer structure 2336 to the circuit board 2302, and may include solder balls (e.g., as shown in FIG. 17), male and female portions of a socket, an adhesive, an underfill material, and/or any other suitable electrical and/or mechanical coupling structure.

The package-on-interposer structure 2336 may include an IC package 2320 coupled to an interposer 2304 by coupling components 2318. The coupling components 2318 may take any suitable form for the application, such as the forms discussed above with reference to the coupling components 2316. The IC package 2320 may be or include, for example, a die (the die 2002 of FIG. 17B), an IC device (e.g., the IC device of FIGS. 1-2), or any other suitable component. In particular, the IC package 2320 may include fill structures as described herein. Although a single IC package 2320 is shown in FIG. 17, multiple IC packages may be coupled to the interposer 2304; indeed, additional interposers may be coupled to the interposer 2304. The interposer 2304 may provide an intervening substrate used to bridge the circuit board 2302 and the IC package 2320. Generally, the interposer 2304 may spread a connection to a wider pitch or reroute a connection to a different connection. For example, the interposer 2304 may couple the IC package 2320 (e.g., a die) to a BGA of the coupling components 2316 for coupling to the circuit board 2302. In the embodiment illustrated in FIG. 17, the IC package 2320 and the circuit board 2302 are attached to opposing sides of the interposer 2304; in other embodiments, the IC package 2320 and the circuit board 2302 may be attached to a same side of the interposer 2304. In some embodiments, three or more components may be interconnected by way of the interposer 2304.

The interposer 2304 may be formed of an epoxy resin, a fiberglass-reinforced epoxy resin, a ceramic material, or a polymer material such as polyimide. In some implementations, the interposer 2304 may be formed of alternate rigid or flexible materials that may include the same materials described above for use in a semiconductor substrate, such as silicon, germanium, and other group III-V and group IV materials. The interposer 2304 may include metal interconnects 2308 and vias 2310, including but not limited to TSVs 2306. The interposer 2304 may further include embedded devices 2314, including both passive and active devices. Such devices may include, but are not limited to, capacitors, decoupling capacitors, resistors, inductors, fuses, diodes, transformers, sensors, ESD protection devices, and memory devices. More complex devices such as further RF devices, power amplifiers, power management devices, antennas, arrays, sensors, and microelectromechanical systems (MEMS) devices may also be formed on the interposer 2304. In some embodiments, the IC devices implementing fill structures as described herein may also be implemented in/on the interposer 2304. The package-on-interposer structure 2336 may take the form of any of the package-on-interposer structures known in the art.

The IC device assembly 2300 may include an IC package 2324 coupled to the first face 2340 of the circuit board 2302 by coupling components 2322. The coupling components 2322 may take the form of any of the embodiments discussed above with reference to the coupling components 2316, and the IC package 2324 may take the form of any of the embodiments discussed above with reference to the IC package 2320.

The IC device assembly 2300 illustrated in FIG. 17 includes a package-on-package structure 2334 coupled to the second face 2342 of the circuit board 2302 by coupling components 2328. The package-on-package structure 2334 may include an IC package 2326 and an IC package 2332 coupled together by coupling components 2330 such that the IC package 2326 is disposed between the circuit board 2302 and the IC package 2332. The coupling components 2328 and 2330 may take the form of any of the embodiments of the coupling components 2316 discussed above, and the IC packages 2326 and 2332 may take the form of any of the embodiments of the IC package 2320 discussed above. The package-on-package structure 2334 may be configured in accordance with any of the package-on-package structures known in the art.

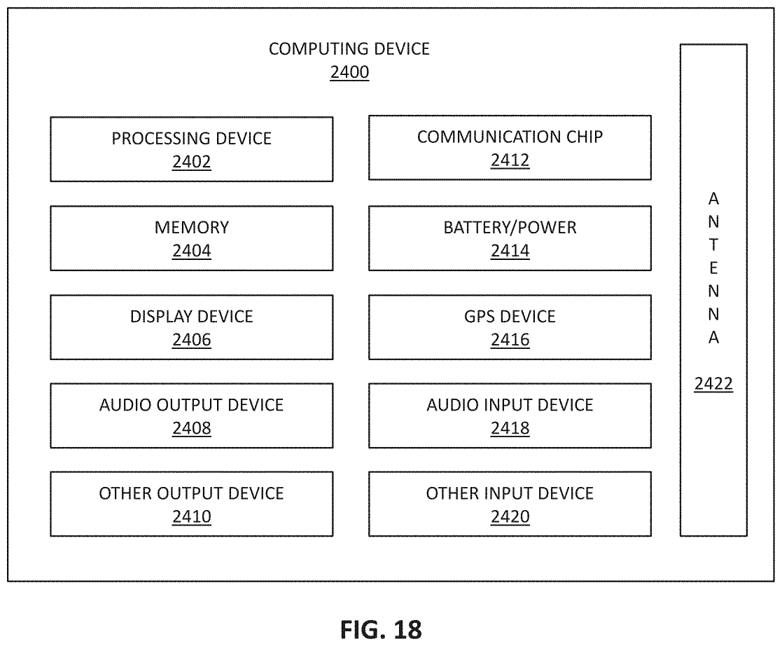

FIG. 18 is a block diagram of an example computing device 2400, according to some embodiments of the disclosure. For example, any suitable ones of the components of the computing device 2400 may include a die (e.g., the die 2002 of FIG. 15B) including fill structures, according to some embodiments of the disclosure. Any of the components of the computing device 2400 may include an IC device (e.g., any embodiment of the IC devices of FIGS. 1-12) and/or an IC package (e.g., the IC package 2200 of FIG. 16). Any of the components of the computing device 2400 may include an IC device assembly (e.g., the IC device assembly 2300 of FIG. 17).

A number of components are illustrated in FIG. 18 as included in the computing device 2400, but any one or more of these components may be omitted or duplicated, as suitable for the application. In some embodiments, some or all of the components included in the computing device 2400 may be attached to one or more motherboards. In some embodiments, some or all of these components are fabricated onto a single system-on-chip (SoC) die.

Additionally, in various embodiments, the computing device 2400 may not include one or more of the components illustrated in FIG. 18, but the computing device 2400 may include interface circuitry for coupling to the one or more components. For example, the computing device 2400 may not include a display device 2406, but may include display device interface circuitry (e.g., a connector and driver circuitry) to which a display device 2406 may be coupled. In another set of examples, the computing device 2400 may not include an audio input device 2418 or an audio output device 2408, but may include audio input or output device interface circuitry (e.g., connectors and supporting circuitry) to which an audio input device 2418 or audio output device 2408 may be coupled.

The computing device 2400 may include a processing device 2402 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 2402 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing device 2400 may include a memory 2404, which may itself include one or more memory devices such as volatile memory (e.g., DRAM), nonvolatile memory (e.g., read-only memory (ROM)), flash memory, solid-state memory, and/or a hard drive. In some embodiments, the memory 2404 may include memory that shares a die with the processing device 2402. This memory may be used as cache memory and may include, e.g., eDRAM, and/or spin transfer torque magnetic random-access memory (STT-MRAM).

In some embodiments, the memory 2404 includes one or more non-transitory computer-readable media storing instructions executable to perform operations for providing fill patterns for IC devices, e.g., the method 1300 described above in conjunction with FIG. 13 or the method 1400 described above in conjunction with FIG. 14. The instructions stored in the one or more non-transitory computer-readable media may be executed by the processing device 2402.

In some embodiments, the computing device 2400 may include a communication chip 2412 (e.g., one or more communication chips). For example, the communication chip 2412 may be configured for managing wireless communications for the transfer of data to and from the computing device 2400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2412 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2412 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2412 may operate in accordance with other wireless protocols in other embodiments. The computing device 2400 may include an antenna 2422 to facilitate wireless communications and/or to receive other wireless communications (such as AM or FM radio transmissions).

In some embodiments, the communication chip 2412 may manage wired communications, such as electrical, optical, or any other suitable communication protocols (e.g., the Ethernet). As noted above, the communication chip 2412 may include multiple communication chips. For instance, a first communication chip 2412 may be dedicated to shorter-range wireless communications such as Wi-Fi or Bluetooth, and a second communication chip 2412 may be dedicated to longer-range wireless communications such as global positioning system (GPS), EDGE, GPRS, CDMA, WiMAX, LTE, EV-DO, or others. In some embodiments, a first communication chip 2412 may be dedicated to wireless communications, and a second communication chip 2412 may be dedicated to wired communications.

In various embodiments, IC devices having fill structures as described herein may be particularly advantageous for use as part of ESD circuits protecting power amplifiers, low-noise amplifiers, filters (including arrays of filters and filter banks), switches, or other active components. In some embodiments, IC devices having one or more BPRs as described herein may be used in PMICs, e.g., as a rectifying diode for large currents. In some embodiments, IC devices having fill structures as described herein may be used in audio devices and/or in various input/output devices.

The computing device 2400 may include battery/power circuitry 2414. The battery/power circuitry 2414 may include one or more energy storage devices (e.g., batteries or capacitors) and/or circuitry for coupling components of the computing device 2400 to an energy source separate from the computing device 2400 (e.g., AC line power).

The computing device 2400 may include a display device 2406 (or corresponding interface circuitry, as discussed above). The display device 2406 may include any visual indicators, such as a heads-up display, a computer monitor, a projector, a touchscreen display, a liquid crystal display (LCD), a light-emitting diode display, or a flat panel display, for example.

The computing device 2400 may include an audio output device 2408 (or corresponding interface circuitry, as discussed above). The audio output device 2408 may include any device that generates an audible indicator, such as speakers, headsets, or earbuds, for example.

The computing device 2400 may include an audio input device 2418 (or corresponding interface circuitry, as discussed above). The audio input device 2418 may include any device that generates a signal representative of a sound, such as microphones, microphone arrays, or digital instruments (e.g., instruments having a musical instrument digital interface (MIDI) output).

The computing device 2400 may include a GPS device 2416 (or corresponding interface circuitry, as discussed above). The GPS device 2416 may be in communication with a satellite-based system and may receive a location of the computing device 2400, as known in the art.

The computing device 2400 may include an other output device 2410 (or corresponding interface circuitry, as discussed above). Examples of the other output device 2410 may include an audio codec, a video codec, a printer, a wired or wireless transmitter for providing information to other devices, or an additional storage device.

The computing device 2400 may include an other input device 2420 (or corresponding interface circuitry, as discussed above). Examples of the other input device 2420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2400 may have any desired form factor, such as a handheld or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device. In some embodiments, the computing device 2400 may be any other electronic device that processes data.

Example 1 provides a computer-implemented method for providing a fill pattern for an IC device, the method including: detecting a first object and a second object in an image that represents the IC device, where the first object represents a first device in the IC device, and the second object represents a second device in the IC device; defining a line in the image based on the first object and the second object so that the image includes a first section that is on a first side of the line and a second section that is on a second side of the line, where the first object is at least partially located in the first section, and the second object is at least partially located in the second section; generating a first structure based on the first object; generating a second structure based on the second object, where the second structure is a mirror image of the first structure across the line; generating a first fill pattern for the first section based on the first structure, the first fill pattern including a first fill structure in the first section; and generating a second fill pattern based on the first fill pattern, the second fill pattern being a mirror image of the first fill pattern across the line and including a second fill structure in the second section, where the first fill pattern and the second fill pattern represent patterns of fill structures to be included in the IC device.

Example 2 provides the computer-implemented method according to example 1, where the first structure or the second structure has a shape that combines a shape of the first object and a shape of the second object.

Example 3 provides the computer-implemented method according to example 1 or 2, where the first structure has a shape that is substantially identical to a shape of the first object or the second object.

Example 4 provides the computer-implemented method according to any of the preceding examples, where, prior to generating the second fill pattern based on the first fill pattern, the computer-implemented method further includes: generating a third fill pattern for the second section based on the second structure, the third fill pattern including a third fill structure in the second section, determining that a distance from the first fill structure to the first object is longer than a distance from the third fill structure to the second object, and selecting the first fill pattern over the third fill pattern.

Example 5 provides the computer-implemented method according to any of the preceding examples, further including: defining a different line based on the first object and the second object so that the image includes a third section on a first side of the different line and a fourth section that is on a second side of the different line, where the first object at least partially located in the third section, and the second object is at least partially located in the fourth section; generating a third fill pattern including a third fill structure in the third section; and generating a fourth fill pattern including a fourth fill structure in the fourth section, where the fourth fill pattern is a mirror image of the third fill pattern across the different line.

Example 6 provides the computer-implemented method according to any of the preceding examples, where the first fill pattern is substantially identical to the second fill pattern.

Example 7 provides the computer-implemented method according to any of the preceding examples, where defining the line in the image includes: identifying a symmetry axis or a symmetry point of the IC device, where the line is the symmetry axis, or the line crosses the symmetry point.

Example 8 provides a computer-implemented method for providing a fill pattern for an IC object, the method including: detecting a first object and a second object in an image that represents the IC device, where the first object represents a first device in the IC device, and the second object represents a second device in the IC device; generating a fill pattern in the image, the fill pattern representing a pattern of fill structures to be included in the IC device; simulating an electrical or mechanical impact of the fill structures on the first device or the second device based on the image; identify a region in the image based on the electrical or mechanical impact; and modifying a portion of the fill pattern to generate a modified fill pattern in the image, where: the portion is in the region, the modified fill pattern represents a pattern of modified fill structures to be included in the IC device, and a simulated electrical or mechanical impact of the modified fill structures on the first device or the second device is less than the electrical or mechanical impact of the fill structures on the first device or the second device.

Example 9 provides the computer-implemented method according to example 8, where simulating the electrical or mechanical impact of the fill structures on the first device or the second device includes: simulating a first mechanical stress applied by at least some of the fill structures on the first device; simulating a second mechanical stress applied by at least some of the fill structures on the second device; and determine whether the first mechanical stress matches the second mechanical stress.

Example 10 provides the computer-implemented method according to example 8 or 9, where simulating the electrical or mechanical impact of the fill structures on the first device or the second device includes: simulating a first capacitance between the first device and a third device in the IC device; simulating a second capacitance between the second device and the third device in the IC device; and determining whether the first capacitance matches the second capacitance.

Example 11 provides an IC device, including: a first fill pattern including first fill structures; a second fill pattern including second fill structures, where the second fill pattern a mirror image of the first fill pattern across a line in the IC device; a first device, at least partially surrounded by the first fill structures and at least partially located at a first side of the line; a second device, at least partially surrounded by the second fill structures and at least partially located at a second side of the line, where the second side is opposite the first side.

Example 12 provides the IC device according to example 11, further including a fill structure, a portion of which is located on the line.

Example 13 provides the IC device according to example 11 or 12, where the fill structure has a line symmetry across the line.

Example 14 provides the IC device according to any one of examples 11-13, where an individual first fill structure or an individual second fill structure includes a metal that is not connected to any of a signal source, a power source, or a reference potential during operation of the IC device.

Example 15 provides the IC device according to any one of examples 11-14, where a portion of the first device is a mirror image of a portion of the second device across the line.

Example 16 provides the IC device according to any one of examples 11-15, where a first portion of the first device is a mirror image of a second portion of the first device across the line.

Example 17 provides the IC device according to any one of examples 11-16, further including: a third fill pattern including third fill structures; and a fourth fill pattern including fourth fill structures, where: the third fill pattern is a mirror image of the fourth fill pattern across a different line in the IC device, the first device is at least partially surrounded by the third fill structures, and the second device is at least partially surrounded by the fourth fill structures.

Example 18 provides the IC device according to any one of examples 11-17, further including: a first layer including the first device, the second device, the first fill pattern, and the second fill pattern; and a second layer over the first layer, the second layer including a third fill pattern and a fourth fill pattern, where the third fill pattern is a mirror image of the fourth fill pattern across an additional line in the second layer, where the additional line is over the line.

Example 19 provides the IC device according to any one of examples 11-18, further including: a first layer including the first device, the second device, the first fill pattern, and the second fill pattern; and a second layer over the first layer, the second layer including a fill structure over the first device or the second device.

Example 20 provides the IC device according to any one of examples 11-19, where the first fill pattern is substantially identical to the second fill pattern.

Example 21 provides an IC package, including the IC device according to any one of examples 11-20; and a further IC component, coupled to the IC device.

Example 22 provides the IC package according to example 21, where the further IC component includes one of a package substrate, an interposer, or a further IC die.

Example 23 provides the IC package according to example 21 or 22, where the IC device according to any one of examples 11-20 may include, or be a part of, at least one of a memory device, a computing device, a wearable device, a handheld electronic device, and a wireless communications device.

Example 24 provides an electronic device, including a carrier substrate; and one or more of the IC devices according to any one of examples 11-20 and the IC package according to any one of examples 21-23, coupled to the carrier substrate.

Example 25 provides the electronic device according to example 24, where the carrier substrate is a motherboard.

Example 26 provides the electronic device according to example 24, where the carrier substrate is a PCB.

Example 27 provides the electronic device according to any one of examples 24-26, where the electronic device is a wearable electronic device or handheld electronic device.

Example 28 provides the electronic device according to any one of examples 24-27, where the electronic device further includes one or more communication chips and an antenna.

Example 29 provides the electronic device according to any one of examples 24-28, where the electronic device is an RF transceiver.

Example 30 provides the electronic device according to any one of examples 24-28, where the electronic device is one of a switch, a power amplifier, a low-noise amplifier, a filter, a filter bank, a duplexer, an upconverter, or a downconverter of an RF communications device, e.g., of an RF transceiver.

Example 31 provides the electronic device according to any one of examples 24-30, where the electronic device is a computing device.

Example 32 provides the electronic device according to any one of examples 24-31, where the electronic device is included in a base station of a wireless communication system.

Example 33 provides the electronic device according to any one of examples 24-31, where the electronic device is included in a user equipment device of a wireless communication system.

Example 34 provides the method according to any one of examples 1-10, further including processes for forming the IC device according to any one of claims 11-20.

Example 35 provides the method according to any one of examples 1-10, further including processes for forming the IC package according to any one of the claims 21-23.

Example 36 provides the method according to any one of examples 1-10, further including processes for forming the electronic device according to any one of the claims 24-31.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method for providing a fill pattern for an integrated circuit (IC) device, the method comprising:
detecting a first object and a second object in an image that represents the IC device, wherein the first object represents a first device in the IC device, and the second object represents a second device in the IC device;
defining a line in the image based on the first object and the second object so that the image includes a first section that is on a first side of the line and a second section that is on a second side of the line, wherein the first object is at least partially located in the first section, and the second object is at least partially located in the second section;
generating a first structure based on the first object;
generating a second structure based on the second object, wherein the second structure is a mirror image of the first structure across the line;
generating a first fill pattern for the first section based on the first structure, the first fill pattern comprising a first fill structure in the first section; and
generating a second fill pattern based on the first fill pattern, the second fill pattern being a mirror image of the first fill pattern across the line and comprising a second fill structure in the second section,
wherein the first fill pattern and the second fill pattern represent patterns of fill structures to be included in the IC device.

2. The computer-implemented method according to claim 1, wherein the first structure or the second structure has a shape that combines a shape of the first object and a shape of the second object.

3. The computer-implemented method according to claim 1, wherein the first structure has a shape that is substantially identical to a shape of the first object or the second object.

4. The computer-implemented method according to claim 1, wherein, prior to generating the second fill pattern based on the first fill pattern, the computer-implemented method further includes:
generating a third fill pattern for the second section based on the second structure, the third fill pattern comprising a third fill structure in the second section,
determining that a distance from the first fill structure to the first object is longer than a distance from the third fill structure to the second object, and
selecting the first fill pattern over the third fill pattern.

5. The computer-implemented method according to claim 1, further comprising:
defining a different line based on the first object and the second object so that the image includes a third section on a first side of the different line and a fourth section that is on a second side of the different line, wherein the first object at least partially located in the third section, and the second object is at least partially located in the fourth section;
generating a third fill pattern comprising a third fill structure in the third section; and
generating a fourth fill pattern comprising a fourth fill structure in the fourth section,
wherein the fourth fill pattern is a mirror image of the third fill pattern across the different line.

6. The computer-implemented method according to claim 1, wherein the first fill pattern is substantially identical to the second fill pattern.

7. The computer-implemented method according to claim 1, wherein defining the line in the image comprises:
identifying a symmetry axis or a symmetry point of the IC device,
wherein the line is the symmetry axis, or the line crosses the symmetry point.

8. A computer-implemented method for providing a fill pattern for an integrated circuit (IC) device, the method comprising:
detecting a first object and a second object in an image that represents the IC device, wherein the first object represents a first device in the IC device, and the second object represents a second device in the IC device;
generating a fill pattern in the image, the fill pattern representing a pattern of fill structures to be included in the IC device;
simulating an electrical or mechanical impact of the fill structures on the first device or the second device based on the image;
identify a region in the image based on the electrical or mechanical impact; and
modifying a portion of the fill pattern to generate a modified fill pattern in the image,
wherein:
the portion is in the region,
the modified fill pattern represents a pattern of modified fill structures to be included in the IC device, and
a simulated electrical or mechanical impact of the modified fill structures on the first device or the second device is less than the electrical or mechanical impact of the fill structures on the first device or the second device.

9. The computer-implemented method according to claim 8, wherein simulating the electrical or mechanical impact of the fill structures on the first device or the second device comprises:
simulating a first mechanical stress applied by at least some of the fill structures on the first device;
simulating a second mechanical stress applied by at least some of the fill structures on the second device; and
determine whether the first mechanical stress matches the second mechanical stress.

10. The computer-implemented method according to claim 8, wherein simulating the electrical or mechanical impact of the fill structures on the first device or the second device comprises:
simulating a first capacitance between the first device and a third device in the IC device;
simulating a second capacitance between the second device and the third device in the IC device; and
determining whether the first capacitance matches the second capacitance.

11. An integrated circuit (IC) device, comprising:
a first fill pattern comprising first fill structures;
a second fill pattern comprising second fill structures, wherein the second fill pattern a mirror image of the first fill pattern across a line in the IC device;
a first device, at least partially surrounded by the first fill structures and at least partially located at a first side of the line;
a second device, at least partially surrounded by the second fill structures and at least partially located at a second side of the line, wherein the second side is opposite the first side.

12. The IC device according to claim 11, further comprising a fill structure, a portion of which is located on the line.

13. The IC device according to claim 11, wherein the fill structure has a line symmetry across the line.

14. The IC device according to claim 11, wherein an individual first fill structure or an individual second fill structure comprises a metal that is not connected to any of a signal source, a power source, or a reference potential during operation of the IC device.

15. The IC device according to claim 11, wherein a portion of the first device is a mirror image of a portion of the second device across the line.

16. The IC device according to claim 11, wherein a first portion of the first device is a mirror image of a second portion of the first device across the line.

17. The IC device according to claim 11, further comprising:
a third fill pattern comprising third fill structures; and
a fourth fill pattern comprising fourth fill structures,
wherein:
the third fill pattern is a mirror image of the fourth fill pattern across a different line in the IC device,
the first device is at least partially surrounded by the third fill structures, and
the second device is at least partially surrounded by the fourth fill structures.

18. The IC device according to claim 11, further comprising:
a first layer comprising the first device, the second device, the first fill pattern, and the second fill pattern; and
a second layer over the first layer, the second layer comprising a third fill pattern and a fourth fill pattern, wherein the third fill pattern is a mirror image of the fourth fill pattern across an additional line in the second layer, wherein the additional line is over the line.

19. The IC device according to claim 11, further comprising:
a first layer comprising the first device, the second device, the first fill pattern, and the second fill pattern; and
a second layer over the first layer, the second layer comprising a fill structure over the first device or the second device.

20. The IC device according to claim 11, wherein the first fill pattern is substantially identical to the second fill pattern.
